(19) United States
(12) Patent Application Publication
(10) Pub. No.: US 2024/0389101 A1
(43) Pub. Date: Nov. 21, 2024

(54) POWER HEADROOM REPORT FOR MULTI-PUSCH REPETITIONS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/692,307

(22) PCT Filed: Nov. 8, 2021
(86) PCT No.: PCT/CN2021/129271

§ 371 Date: Mar. 14, 2024

(51) Int. Cl. H04W 72/21; H04W 52/36

(52) U.S. Cl. CPC H04W 72/21; H04W 52/365

(57) ABSTRACT

Method and apparatus for PHR for multi-PUSCH repetitions. The apparatus selects a first PUSCH to carry a first MAC-CE having a first PHR. The apparatus determines a first value of the first PHR based on a third PUSCH. The apparatus selects a second PUSCH to carry a second MAC-CE having a second PHR based on the third PUSCH or the first PUSCH. The apparatus determines a second value of the second PHR based on a fourth PUSCH.

### TECHNICAL FIELD

The present disclosure relates generally to communication systems, and more particularly, to a configuration for power headroom reports for multi-physical uplink shared channel (PUSCH) repetitions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus may select a first physical uplink shared channel (PUSCH) to carry a first medium access control (MAC) control element (CE) (MAC-CE) having a first power headroom report (PHR). The apparatus may determine a first value of the first PHR based on a third PUSCH. The apparatus may select a second PUSCH to carry a second MAC-CE having a second PHR based on the third PUSCH or the first PUSCH. The apparatus may determine a second value of the second PHR based on a fourth PUSCH.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating an example of a cyclical beam mapping pattern.

FIG. 4B is a diagram illustrating an example of a sequential beam mapping pattern.

FIG. 5A is a diagram illustrating an example of sequential TB mapping and cyclical beam mapping pattern.

FIG. 5B is a diagram illustrating an example of cyclic TB mapping and sequential beam mapping pattern.

FIG. 6A is a diagram illustrating an example of a single MAC-CE PHR in a single CC.

FIG. 6B is a diagram illustrating an example of two MAC-CE PHRs in a single CC.

FIG. 7 is a diagram illustrating an example of MAC-CE PHRs in different CCs.

FIG. 8 is a diagram illustrating an example of MAC-CE PHRs in different CCs.

FIG. 9 is a diagram illustrating an example of two MAC-CE PHRs in a single CC.

FIG. 10 is a diagram illustrating an example of MAC-CE PHRs in different CCs.

FIG. 11 is a diagram illustrating an example of MAC-CE PHRs in different CCs.

FIG. 12 is a diagram illustrating an example of MAC-CE PHRs in different CCs.

FIG. 13 is a diagram illustrating an example of a single MAC-CE PHR for carrier aggregation.

FIG. 14 is a diagram illustrating an example of two MAC-CE PHRs in the same CC.

FIG. 15 is a diagram illustrating an example of two MAC-CE PHRs in the same CC.

FIG. 16 is a diagram illustrating an example of two MAC-CE PHRs in the same CC.

FIG. 17 is a diagram illustrating an example of two MAC-CE PHRs in the same CC.

FIG. 18 is a call flow diagram of signaling between a UE and a base station.

FIG. 19 is a flowchart of a method of wireless communication.

FIG. 20 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

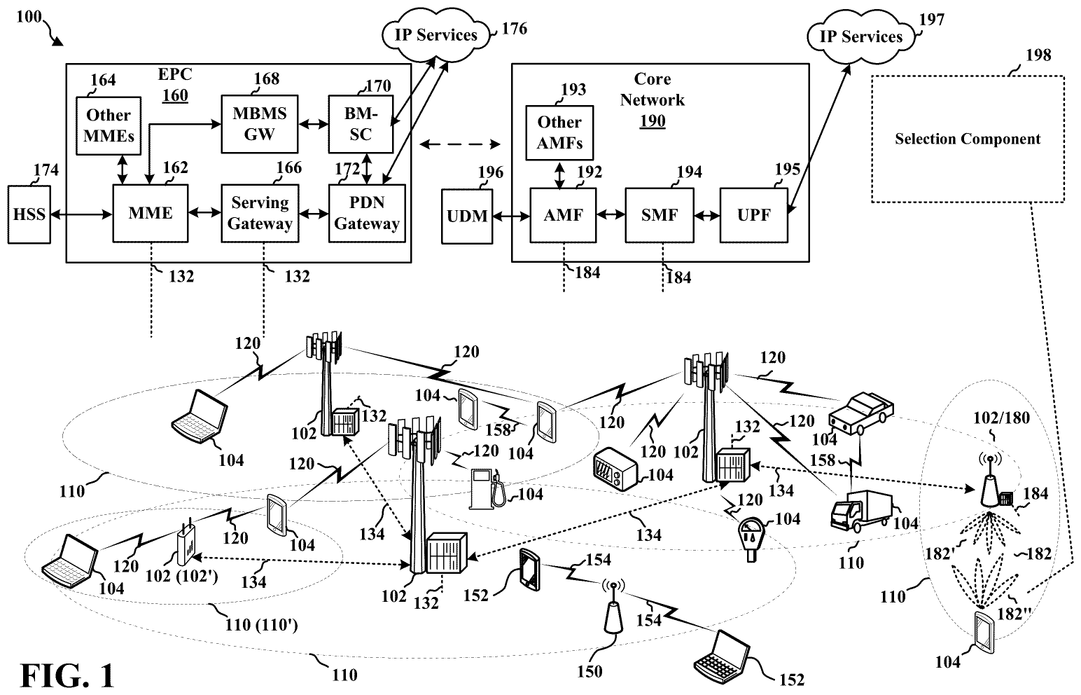

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to determine at least one PUSCH to carry a MAC-CE for PHR. For example, UE 104 may comprise a selection component 198 configured to determine at least one PUSCH to carry a MAC-CE for PHR. The UE 104 may select a first PUSCH to carry a first MAC-CE having a first PHR. The UE 104 may determine a first value of the first PHR based on a third PUSCH. The UE 104 may select a second PUSCH to carry a second MAC-CE having a second PHR based on the third PUSCH or the first PUSCH. The UE 104 may determine a second value of the second PHR based on a fourth PUSCH.

Although the following description may be focused on 5G NR, the concepts described herein may be applicable to other similar areas, such as LTE, LTE-A, CDMA, GSM, and other wireless technologies.

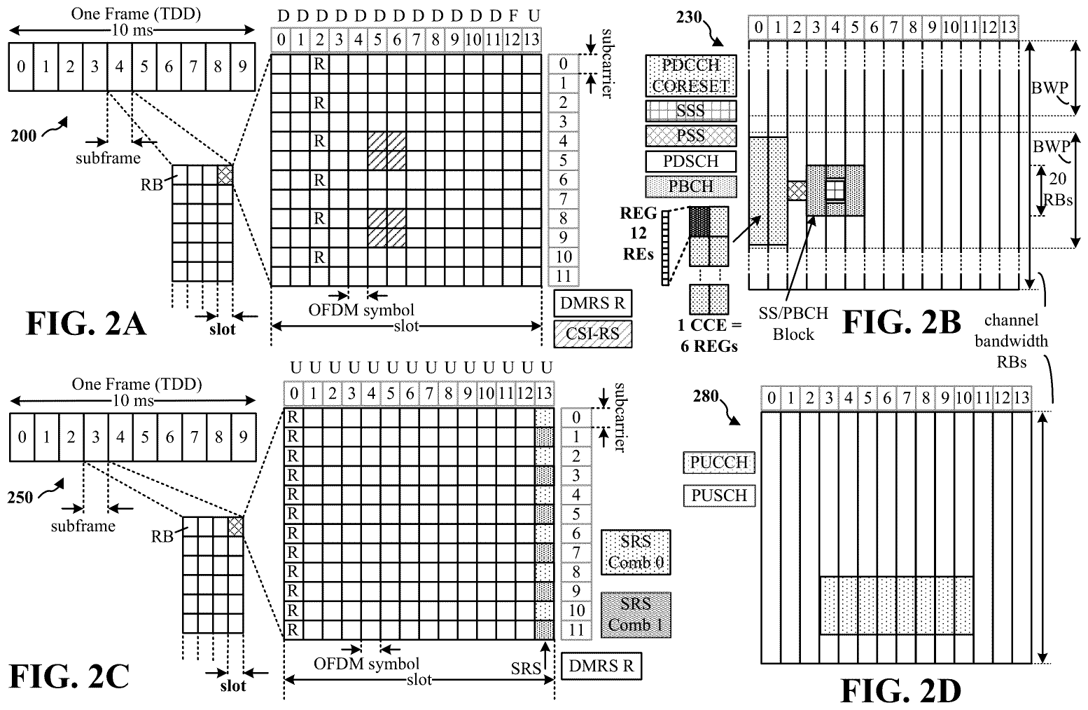

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

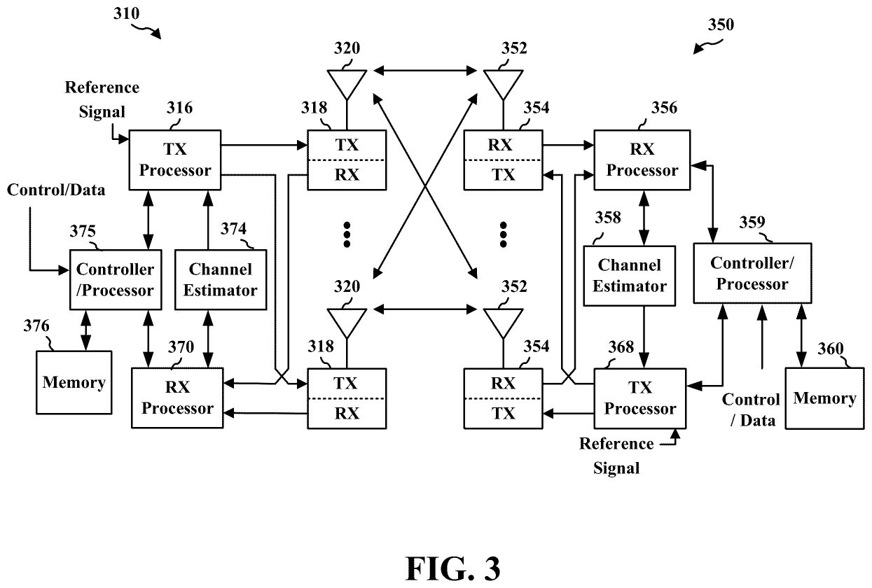

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

In wireless communications, PUSCH repetition may occur using different beams. A multi-TRP configuration may seek to improve reliability and robustness for PUSCH for multi-TRP or multi-panel. For example, if one link is blocked, another repetition may be decoded by another TRP or panel, which increases the diversity. PUSCH repetition may be based on Type A or B. For example, different PUSCH transmission occasions (e.g., repetitions) corresponding to the same TB are transmitted in different slots as in repetition Type A or in mini-slots as in repetition Type B. The number of repetitions may be configured via RRC signaling or may be indicated dynamically through time domain resource allocation (TDRA) field of DCI. All the repetitions may be transmitted with the same beam where the SRS resource indicator (SRI) field of the DCI is applied to all the repetitions. The SRI field is a field in uplink DCI that determines the beam/power control for PUSCH by pointing to one or more SRS resources within an SRS resource set.

In instances where different PUSCH repetitions are intended to be received at different TRPs, panels, or antennas at the base station side, using the same beam for all the repetitions may not be optimal. PUSCH repetitions may belong to two sets where each set has its own beam or power control parameters. The two sets of repetitions may correspond to two SRS resource sets, such that DCI indicates two beams or two sets of power control parameters (e.g., PO, alpha, path loss reference signal (PL-RS), closed loop index) by two corresponding SRI fields. DCI may dynamically switch between PUSCH repetition associated with single SRS resource set and PUSCH repetitions associated with multiple SRS resource sets. The DCI may include a two-bit field that indicates one of use of a first set of parameters, use a second set of parameters, use both sets of parameters for two sets of repetitions with a first order, or use both sets of repetitions with a second order.

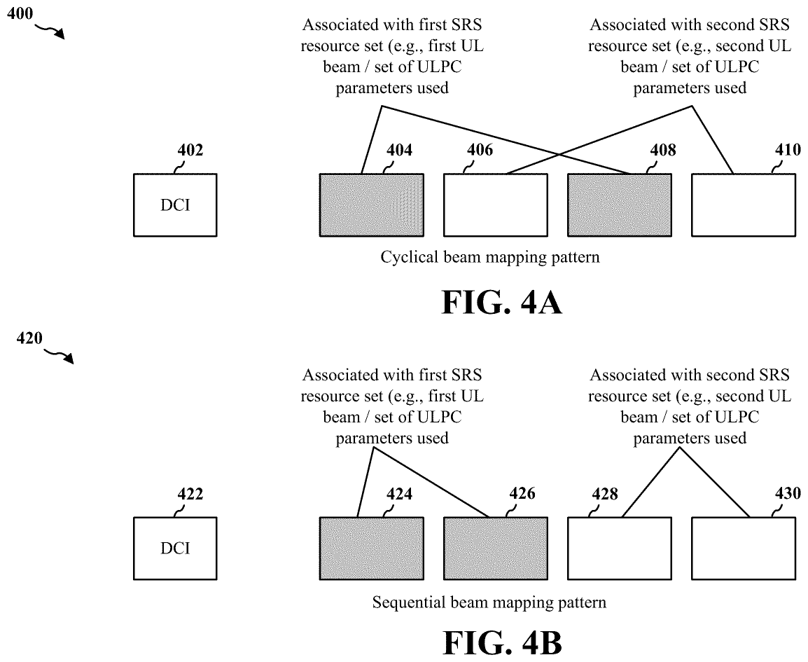

For example, with reference to diagram 400 of FIG. 4A, a DCI 402 may schedule 4 PUSCH repetitions (e.g., 404, 406, 408, 410). The PUSCH repetitions 404 and 408 may be associated with a first SRS resource set where a first uplink beam or set of uplink power control (ULPC) are used. The PUSCH repetitions 404 and 408 may be transmitted using a first beam and targeted toward a first TRP. The PUSCH repetitions 406 and 410 may be associated with a second SRS resource set where a second uplink beam or set of ULPC are used. The PUSCH repetitions 406 and 410 may be transmitted using a second beam and targeted toward a second TRP. The diagram 400 of FIG. 4A provides an example of a cyclical beam mapping pattern.

With reference to diagram 420 of FIG. 4B, a DCI 422 may schedule 4 PUSCH repetitions (e.g., 424, 426, 428, 430). The PUSCH repetitions 424 and 426 may be associated with a first SRS resource set where a first uplink beam or set of ULPC are used. The PUSCH repetitions 424 and 426 may be transmitted using a first beam and targeted toward a first TRP. The PUSCH repetitions 428 and 430 may be associated with a second SRS resource set where a second uplink beam or set of ULPC are used. The PUSCH repetitions 428 and 430 may be transmitted using a second beam and targeted toward a second TRP. The diagram 420 of FIG. 4B provides an example of a sequential beam mapping pattern.

An actual PHR for a CC or serving cell may be determined as follows:

$$\\ {PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{{}_{} μ} \cdot {M}_{RB , b , f , c}^{{}_{} PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

corresponding to an actual PUSCH transmission occasion i. The PC_{MAX,f,c}(i) may correspond to a UE configured maximum output power after backoff due to power management (e.g., backoff due to MPR).

A virtual PHR for a CC or serving cell may be determined as follows:

$$\\ {PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

corresponding to a reference PUSCH transmission (e.g., virtual PHR report). The UE configured maximum output power is computed assuming no backoff. The virtual PHR report may be based on default or reference parameters (e.g., j, i, l, q_{d}). For PO and alpha: p0-PUSCH-AlphaSetId=0. For PL: pusch-PathlossReferenceRS-Id=0, and for closedloopindex: l=0.

PHR may be triggered by the MAC layer and may depend on at least one of a set of timers (e.g., phr-PeriodicTimer, phr-ProhibitTimer), a power change larger than a configurable threshold for PL-RS used for power control in any uplink CC, an activation of a secondary cell (SCell), or an active bandwidth part (BWP) of a configured CC is changed from dormant to non-dormant. When triggered, PHR may be reported in the PHR MAC-CE on a first available PUSCH that corresponds to an initial transmission of a TB that can accommodate the MAC-CE as a result of logical channel prioritization (LCP). In some instances, PUSCH may be dynamic (e.g., scheduled by DCI), or may be scheduled via configured grant (CG). In instances where the UE is configured with multiple CCs for PUSCH transmission, the PHR MAC-CE may include a PHR for more than one CC if multiple PHR is enabled. Otherwise, PHR is reported for the primary cell (PCell) and a single-entry MAC-CE format is used. In instances where a first PUSCH in a first CC carries PHR MAC-CE, a MAC-CE for a second CC may include either an actual PHR or a virtual PHR based on whether there is a PUSCH transmission on the second CC at the time of PHR reporting in the slot of the first PUSCH, or whether the PUSCH transmission on the second CC is scheduled by a DCI that satisfies a timeline condition, otherwise, a virtual PHR is reported.

For PHR reporting related to PUSCH repetitions associated with multiple SRS resource sets, two PHRs may be calculated where each are associated with a first PUSCH occasion to each TRP, where both PHRs are reported.

In instances where both PHRs are reported, when a PHR MAC-CE is reported in a slot n, for a CC that is configured with PUSCH repetitions associated with multiple SRS resource sets, the first PHR value may be reported in the conventional manner, while the second PHR value may be calculated based on whether the first PHR value is an actual PHR corresponding to a repetition associated with a given SRS resource set among PUSCH repetitions associated with multiple SRS resource sets, the second PHR value may be actual when a repetition associated with the other SRS resource set is transmitted in slot n, otherwise the second PHR value is a virtual value. If there are multiple repetition associated with the other SRS resource set in slot n, the earliest one in slot n is selected. In some instances, if the first PHR value is an actual PHR but does not correspond to a repetition among PUSCH repetitions associated with multiple SRS resource sets (e.g., corresponds to a PUSCH associated with a single SRS resource set), then the second PHR value is reported as a virtual PHR. If the first PHR value is virtual, then a second PHR value is reported as a virtual PHR. If the second PHR is virtual, the second PHR may be calculated based on a set of default power control parameters defined for the other SRS resource sets that are not associated with the first PHR.

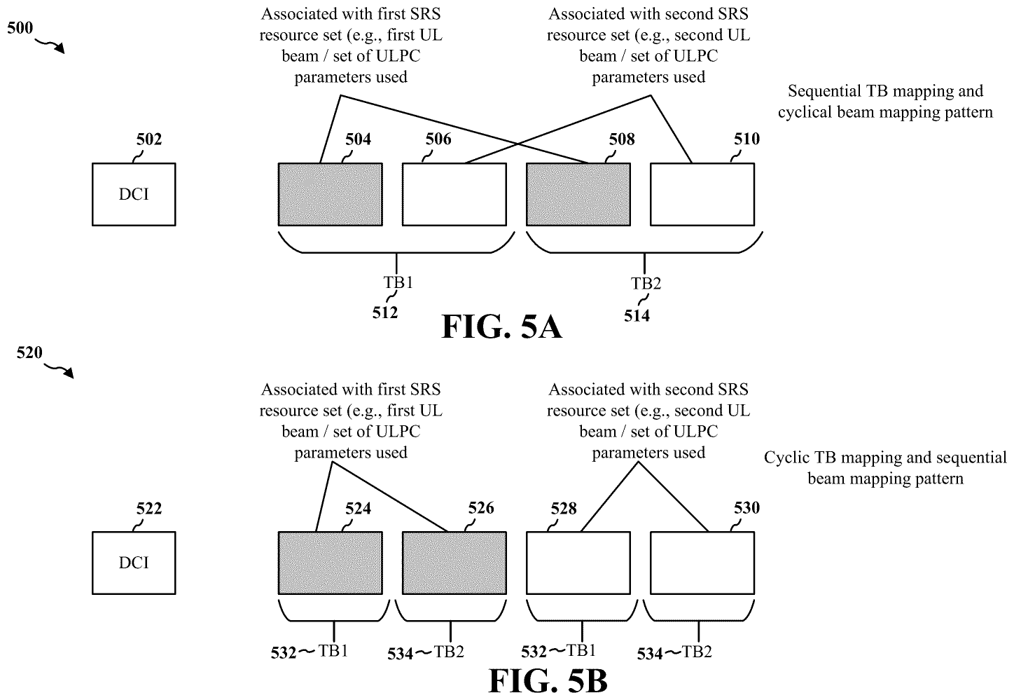

For multi-PUSCH repetitions with different beams, a single DCI may schedule multiple PUSCHs each with multiple repetitions in an effort to reduce DCI overhead. In such instances, to improve the reliability and robustness for each PUSCH or TB, different PUSCH repetitions of a given PUSCH or TB may be received at different TRPs, panels, or antennas at the base station. PUSCH repetitions of a given TB may belong to two sets, where each set has its own beam or power control parameters. For a given TB, the two sets of repetitions may correspond to two SRS resource sets, where the DCI indicates two beams or two sets of power control parameters (e.g., PO, alpha, PL-RS, close-loop index) by two corresponding SRI fields. Different TBs may have different open loop power control parameters. With reference to diagram 500 of FIG. 5A, a DCI 502 may schedule 2 PUSCHs and/or TBs each with two repetitions. The PUSCH repetitions 504 and 508 may be associated with a first SRS resource set, where a first uplink beam or set of ULPC parameters are used. PUSCH repetitions 504 and 508 may be transmitted using a first beam (e.g., targeted towards a first TRP), while PUSCH repetitions 506 and 510 may be transmitted using a second beam (e.g., targeted towards a second TRP). The PUSCH repetitions 506 and 510 may be associated with a second SRS resource set, where a second uplink beam or set of ULPC parameters are used. The PUSCH repetitions 504 and 506 may be within TB1 512, while PUSCH repetitions 508 and 510 may be within TB2 514. The diagram 500 of FIG. 5A may provide an example of sequential TB mapping and cyclical beam mapping pattern.

With reference to diagram 520 of FIG. 5B, a DCI 522 may schedule two PUSCHs and/or TBs each with two repetitions. The PUSCH repetitions 524 and 526 may be associated with a first SRS resource set, where a first uplink beam or set of ULPC parameters are used. PUSCH repetitions 524 and 526 may be transmitted using a first beam (e.g., targeted towards a first TRP). The PUSCH repetitions 528 and 530 may be associated with a second SRS resource set, where a second uplink beam or set of ULPC parameters are used. PUSCH repetitions 528 and 530 may be transmitted using a second beam (e.g., targeted towards a second TRP). The PUSCH repetitions 524 and 528 may be within TB1 532, while PUSCH repetitions 526 and 530 may be within TB2 534. The diagram 520 may provide an example of cyclic TB mapping and sequential beam mapping pattern.

For multi-PUSCH scheduling each with multiple repetitions, different open loop power control parameters (e.g., PO) may be applied for different TBs. For a given TB, two sets of power control parameters (e.g., PO, alpha, PL-RS, close loop index) may be applied. Different TBs as well as different repetitions of a given TB may have different PHRs. The PHR difference between different TBs may be due to different PO only, such that if a base station knows the PHR for one PUSCH or TB associated with a given SRS resource set/beam, then the base station may determine the PHR for other TBs associated with the same SRS resource set/beam based on the PO difference. For multi-PUSCH scheduling each with multiple repetitions, different TBs may carry different MAC-CEs, such that different PHRs may be carried in different MAC-CEs.

Aspects presented herein provide a configuration for power headroom reports for multi-PUSCH repetitions. For example, the disclosure may determine which PUSCH may be used to carry a MAC-CE for PHR. In some instances, the disclosure may determine the PHR value for each of the MAC-CEs.

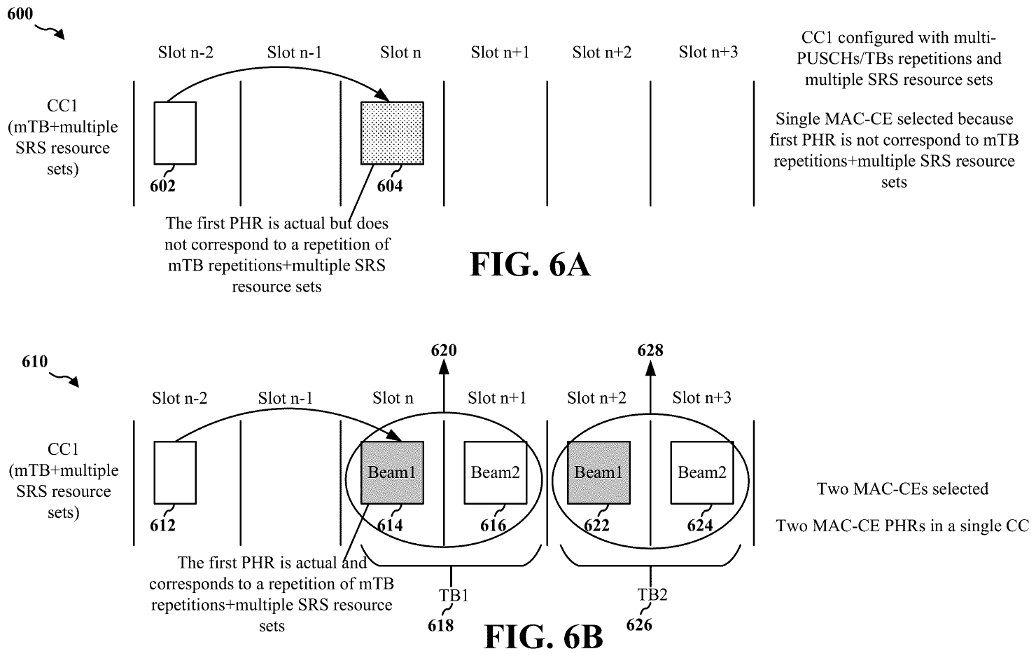

In some instances, if at least one CC is configured with multi-PUSCHs/TBs repetitions associated with multiple SRS resource sets, when PHR is triggered the UE may first select a first PUSCH to carry the MAC-CE for the first PHR in a first CC such that the first PHR MAC-CE is reported in a slot n. The UE may then determine the second PUSCH to carry the MAC-CE for the second PHR based on the PUSCH for the first PHR calculation. The first PHR may be reported in the PHR MAC-CE in a first available PUSCH corresponding to an initial transmission of a first TB that can accommodate the first MAC-CE as a result of LCP. For example, with reference to diagram 600 of FIG. 6A, a CC1 may be configured multi-PUSCHs/TB repetitions associated with multiple SRS resource sets, e.g., two SRS resource sets. The DCI 602 may schedule a PUSCH 604. The UE may select to transmit the PUSCH 604 in slot n. The PUSCH 604 may carry the first MAC-CE PHR. The first PHR may be actual but may not correspond to a repetition of multi-PUSCH repetitions associated with multiple SRS resource sets, e.g., two SRS resource sets. As such, a single MAC-CE is selected because the first PHR does not correspond to a repetition of multi-PUSCH repetitions associated with multiple SRS resource sets, e.g., two SRS resource sets. The diagram 600 provides an example of a single MAC-CE PHR in a single CC.

In some instances, if the first PHR value is actual and corresponds to a transmission occasion associated with a given SRS resource set among multiple repetitions across multiple TBs associated with multiple SRS resource sets, e.g., two SRS resource sets, the UE may select a second PUSCH to carry the MAC-CE for the second PHR on a second CC. The second PHR may be reported in the PHR MAC-CE on a first available PUSCH corresponding to an initial transmission of a transmission of a second TB that is different from the TB in slot n in the same CC and may accommodate the second MAC-CE as a result of LCP.

With reference to diagram 610 of FIG. 6B, a CC1 may be configured with multi-PUSCHs/TB repetitions associated with multiple SRS resource sets, e.g., two SRS resource sets. The DCI 612 may schedule multip-PUSCHs each with multiple repetitions. A first repetition 614 of the PUSCH may be scheduled for transmission using Beam1, while a second repetition 616 of the PUSCH may be scheduled for transmission using Beam2. Beam1 may be associated with a first SRS resource set using a first uplink beam and set of ULPC parameters. Beam2 may be associated with a second SRS resource set using a second uplink beam and set of ULPC parameters. Repetitions 614 and 616 may correspond to a first transport block TB1 618. A third repetition 622 may be scheduled for transmission using Beam1, while a fourth repetition 624 may be scheduled for transmission using Beam2. Repetitions 622 and 624 may correspond to a second transport block TB2 626. The UE may select a first MAC-CE 620 to carry a first MAC-CE PHR within CC1, and select a second MAC-CE 628 to carry a second MAC-CE PHR also within CC1.

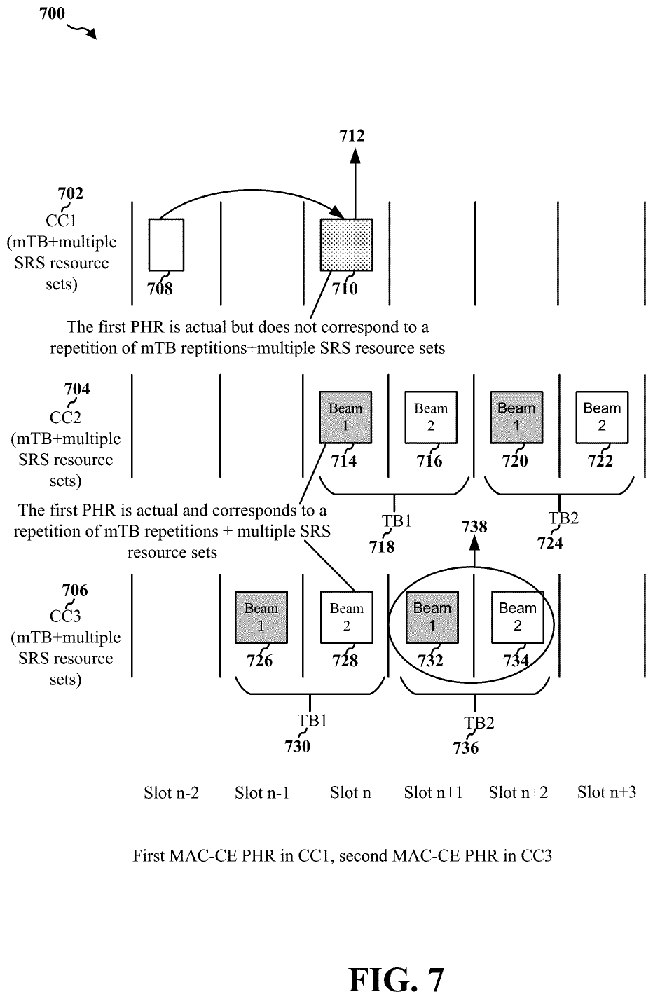

With reference to 700 of FIG. 7, DCI 760 may schedule a PUSCH with multiple repetitions. The UE may select a first MAC-CE to carry a first PHR on a first PUSCH 712 within CC1 at transmission occasion 710. The first PHR may be actual but may not correspond to a repetition of multi-PUSCH repetitions associated with multiple SRS resource sets, e.g., two SRS resource sets. The UE may be configured to transmit multi-PUSCH repetitions associated with two SRS resource sets (e.g., 714, 716, 720, 722) on CC2 704. Repetition 714 and 720 may be transmitted via Beam1, while repetitions 716 and 722 may be transmitted via Beam2. The repetitions 714 and 716 may correspond to a first transport block TB1 718, and repetitions 720 and 722 may correspond to a second transport block TB2 724. The UE may be configured to transmit multi-PUSCH repetitions associated with two SRS resource sets (e.g., 726, 728, 732, 734) on CC3 706. Repetitions 726 and 732 may be transmitted via Beam1, while repetitions 728 and 734 may be transmitted via Beam2. The repetitions 726 and 728 may correspond to a first transport block TB1 730, and repetitions 732 and 734 may correspond to a second transport block TB2 736. Repetition 714 and 728 may be scheduled for transmission in slot n, which is the same as slot of the first MAC-CE 710, and are both associated with a repetition of multi-PUSCH repetitions associated with two SRS resource sets. Repetition 732 may correspond to an initial transmission of a transmission of the second TB (e.g., TB2 736), as such, the UE may select the second PHR to be reported in a second MAC-CE within a second PUSCH 738 that corresponds to repetitions 732 and 734.

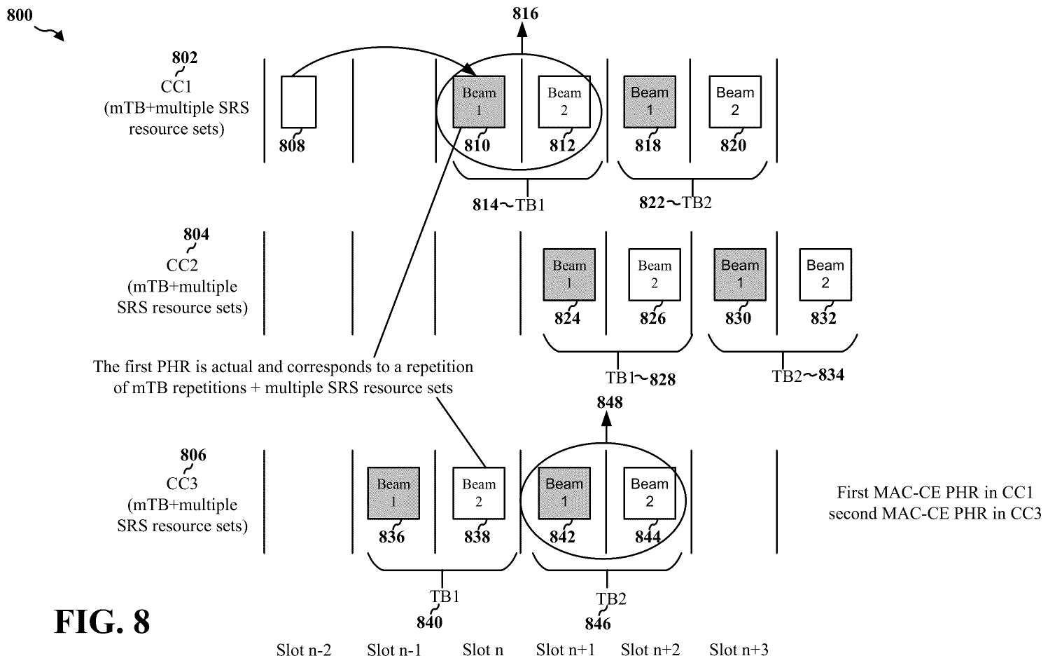

With reference to diagram 800 of FIG. 8, DCI 808 may schedule multi-PUSCH repetitions. Repetitions 810 and 818 may be transmitted via Beam1, while repetitions 812 and 820 may be transmitted via Beam2. Repetitions 810 and 812 may correspond to TB1 814, while repetitions 818 and 820 may correspond to TB2 822. The UE may select a first PUSCH 816 to carry a first MAC-CE PHR within CC1 802. The first PHR is actual and corresponds to a repetition of multi-PUSCH repetitions associated with two SRS resource sets. In CC2 804, repetitions 824 and 830 may be transmitted via Beam1, while repetitions 826 and 832 may be transmitted via Beam2. Repetitions 824 and 826 may correspond to TB1 828, while repetitions 830 and 832 may correspond to TB2 834. In CC3 806, repetitions 836 and 842 may be transmitted via Beam1, while repetitions 838 and 844 may be transmitted via Beam2. Repetitions 836 and 838 may correspond to TB1 840, while repetitions 842 and 844 may correspond to TB2 846. Repetition 842 may correspond to an initial transmission of a transmission of a second TB (e.g., TB2 846), as such, the UE may select the second PHR to be reported in a second MAC-CE within a second PUSCH 848 that corresponds to repetition 842 and 844.

In some instances, for a CC that is configured with multi-PUSCH/TB repetitions associated with multiple SRS resource sets, e.g., two SRS resource sets, the second PHR value may be determined under different circumstances. For example, if the first PHR value is actual and corresponds to a PUSCH transmission occasion associated with a given SRS resource set among multi-PUSCH repetitions associated with two SRS resource sets the second PHR may be actual, under Condition 1, where there are more than one PUSCH transmission occasion associated with the other SRS resource set, the second PHR may be calculated based on at least one of whether there are other PUSCH transmission occasions associated with the other SRS resource set which transmit after the PUSCH transmission occasion used to calculate the first PHR. In such instances, the UE may select the earliest PUSCH transmission occasion. Otherwise, the UE may select the latest transmission occasion which is transmitted before the PUSCH transmission occasion used to calculate the first PHR. In some aspects, the second PHR may be actual, under Condition 2, where a transmission occasion associated with the other SRS resource set is transmitted in the first slot (e.g., slot n) that is overlapped with the one or more slots of the MAC-CE for the second PHR; otherwise the second PHR may be virtual. If there are more than one PUSCH transmission occasions associated with the other SRS resource set, the earliest one in slot n may be selected.

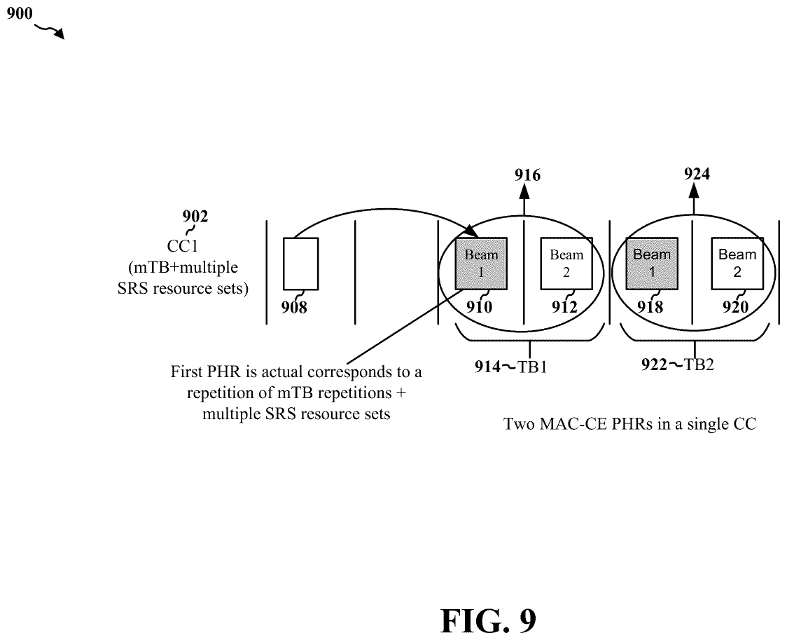

With reference to diagram 900 of FIG. 9, a DCI 908 may schedule multi-PUSCH repetitions. Repetitions 910 and 918 may be transmitted via Beam1, while repetitions 912 and 920 may be transmitted via Beam2. Repetitions 910 and 912 may correspond to TB1 914, while repetitions 918 and 920 may correspond to TB2 922. The UE may select a first PUSCH 916 to carry a first MAC-CE PHR within CC1 902. The first PHR may be actual and may correspond to a repetition of multi-PUSCH repetitions associated with two SRS resource sets. The UE may select a second PUSCH 924 to carry a second MAC-CE PHR within CC1 902. The second PHR may be actual and corresponds to repetition 912 in view of Condition 1. In some instances, the second PHR may be virtual in view of Condition 2.

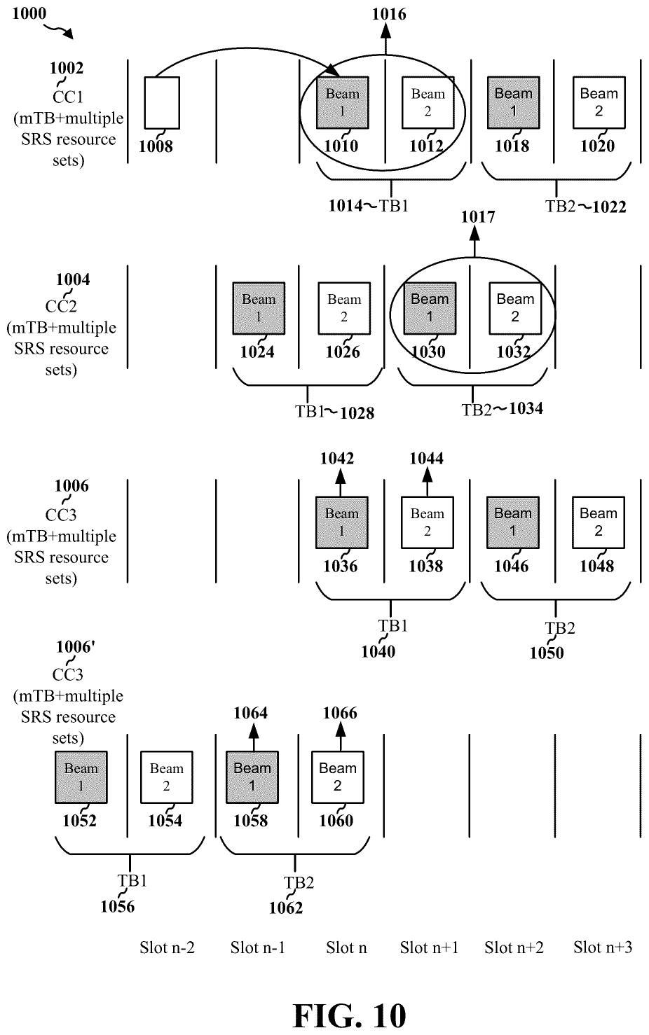

With reference to diagram 1000 of FIG. 10, a DCI 1008 may schedule multi-PUSCH repetitions. Repetitions 1010 and 1018 may be transmitted via Beam1, while repetitions 1012 and 1020 may be transmitted via Beam2. Repetitions 1010 and 1012 may correspond to TB1 1014 within CC1 1002, while repetitions 1018 and 1020 may correspond to TB2 1022 within CC1 1002. In CC2 1004, repetitions 1024 and 1030 may be transmitted via Beam1, while repetitions 1026 and 1032 may be transmitted via Beam2. Repetitions 1024 and 1026 may correspond to TB1 1028 within CC2 1004, while repetitions 1030 and 1032 may correspond to TB2 1034 within CC2 1004. In CC3 1006, repetitions 1036 and 1046 may be transmitted via Beam1, while repetitions 1038 and 1048 may be transmitted via Beam2. Repetitions 1036 and 1038 may correspond to TB1 1040 within CC3 1006, while repetitions 1046 and 1048 may correspond to TB2 1050 within CC3 1006. A first PUSCH 1016 may be selected to carry the first MAC-CE PHR within CC1 1002, and a second PUSCH 1017 may be selected to carry the second MAC-CE PHR within CC2 1004. The first PHR 1042 may be actual and may correspond to a PUSCH transmission occasion associated with a given SRS resource set among multi-PUSCH repetitions associated with two SRS resource sets. In some aspects, the value of the second PHR 1044 may be actual and corresponds to repetition 1038 in view of Condition 1 or Condition 2.

In some instances, such as for CC3 1006′, the value of the second PHR may be different. For example, repetitions 1052 and 1058 may be transmitted via Beam1, while repetitions 1054 and 1060 may be transmitted via Beam2. Repetitions 1052 and 1054 may be associated with TB1 1056 within CC3 1006′ and repetitions 1058 and 1060 may be associated with TB2 1062 within CC3 1006′. In the instance of CC3 1006′, the first PHR 1066 may be actual and may correspond to repetition 1060. In some aspects, the second PHR 1064 may be actual and corresponds to repetition 1058 in view of Condition 1. In some aspects, the second PHR 1064 may be virtual or not reported in view of Condition 2.

In some instances, the first PHR value may be actual but may not correspond to a transmission occasion associated with a given SRS resource set among multi-PUSCH repetitions associated with multiple SRS resource sets, e.g., two SRS resource sets. In such instances, the second PHR may be actual if one or more of the following conditions are satisfied. For example, in Condition 1′, at least one transmission occasion associated with a given SRS resource set among multi-PUSCH repetitions associated with multiple SRS resource sets, e.g., two SRS resource sets is transmitted in the first slot (e.g., slot n) that is overlapped with the one or more slots of the MAC-CE for second PHR. In some aspects, if the first PUSCH transmission occasion among multi-PUSCH repetitions associated with multiple SRS resource sets, e.g., two SRS resource sets in the first slot that is overlapped with the one or more slots of the MAC-CE for the second PHR is associated with an SRS resource set that is different from the SRS resource set of the PUSCH transmission occasion for the first PHR, the second PHR may be calculated based on the first PUSCH transmission occasion in the first slot that is overlapped with the one or more slots of the MAC-CE for the second PHR. Otherwise, the second PHR may be calculated based on the PUSCH transmission occasion that is associated with an SRS resource set that is different from the SRS resource set of the PUSCH transmission occasion for the first PHR and closet to the PUSCH containing MAC-CE for second PHR. In some aspects, the second PHR may be actual, based on Condition 2′, if a transmission occasion associated with an SRS resource set among multi-PUSCH repetitions associated with multiple SRS resource sets, e.g., two SRS resource sets is transmitted in the first slot that is overlapped with the one or more slots of the MAC-CE for second PHR and the SRS resource set is different from the SRS resource set of the PUSCH transmission occasion for the first PHR. If there are multiple transmission occasions associated with the SRS resource set, the earliest one in slot n may be selected. Otherwise, the second PHR may be reported as virtual or may not be reported.

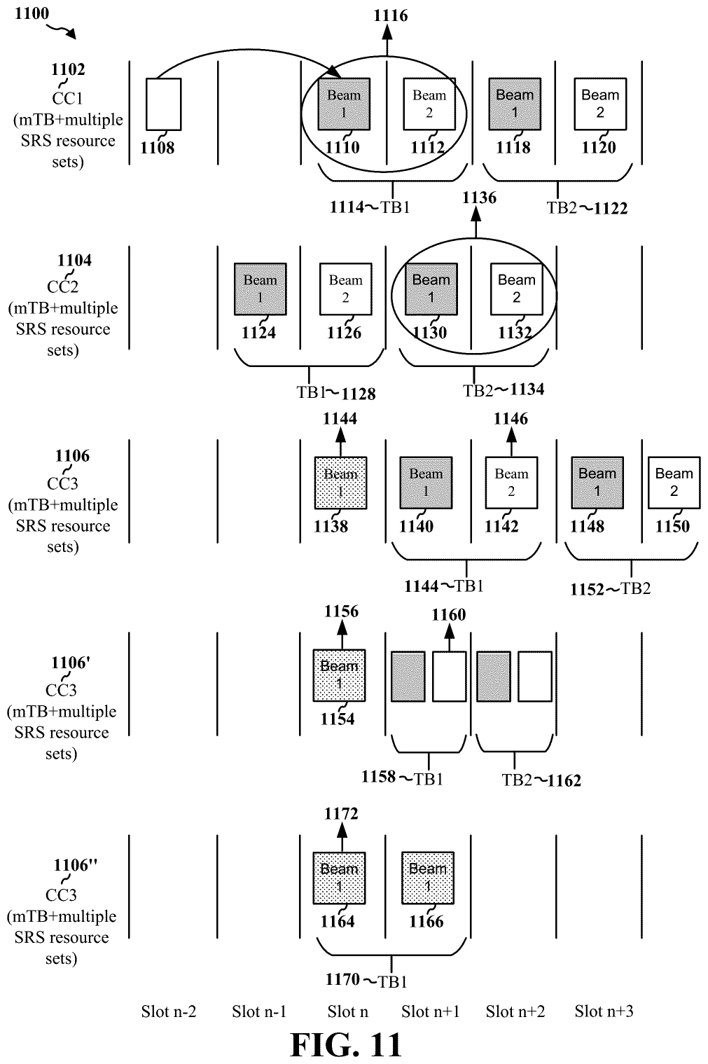

With reference to diagram 1100 of FIG. 11, a DCI 1108 may schedule multi-PUSCH repetitions. Repetitions 1110 and 1118 may be transmitted via Beam1, while repetitions 1112 and 1120 may be transmitted via Beam2. Repetitions 1110 and 1112 may correspond to TB1 1114 within CC1 1102, while repetitions 1118 and 1120 may correspond to TB2 1122 within CC1 1102. In CC2 1104, repetitions 1124 and 1130 may be transmitted via Beam1, while repetitions 1126 and 1132 may be transmitted via Beam2. Repetitions 1124 and 1126 may correspond to TB1 1128 within CC2 1104, while repetitions 1130 and 1132 may correspond to TB2 1134 within CC2 1104. In CC3 1006, repetitions 1138, 1140, and 1148 may be transmitted via Beam1, while repetitions 1142 and 1150 may be transmitted via Beam2. Repetitions 1140 and 1142 may correspond to TB1 1144 within CC3 1106, while repetitions 1148 and 1150 may correspond to TB2 1152 within CC3 1106. A first PUSCH 1116 may be selected to carry the first MAC-CE PHR within CC1 1102, and a second PUSCH 1136 may be selected to carry the second MAC-CE PHR within CC2 1104. The first PHR 1144 in CC3 1106 may be actual but may not correspond to a transmission occasion associated with a given SRS resource set among multi-PUSCH repetitions associated with two SRS resource sets. In some aspects, the second PHR 1146 may be actual and corresponds to repetition 1142 in view of Condition 1′. In some aspects, the second PHR 1146 may be virtual in view of Condition 2′. In some aspects, for example CC3 1106′ may comprise a first PHR 1156 and a second PHR 1160. The second PHR may be actual and corresponds to the second repetition of TB1 1158 in view of Condition 1′ and 2′. In some aspects, for example CC3 1106″ may comprise a first PHR 1172. However, transmission occasions 1164 and 1166 do not correspond to transmission occasions associated with a give SRS resource set among multi-PUSCH repetitions associated with two SRS resource sets. As such, the second PHR is virtual or not reported.

In some instances, the first PHR may be virtual. The second PHR may be actual if one or more of the following conditions are satisfied. For example, in Condition 1″, at least one transmission occasion may be associated with a second SRS resource set among multi-PUSCH repetitions associated with two SRS resource sets is transmitted in the first slot (e.g., slot n) that is overlapped with the one or more slots of the MAC-CE for second PHR. In some aspects, if the first PUSCH transmission occasion among multi-PUSCH repetitions associated with two SRS resource sets in the first slot that is overlapped with the one or more slots of the MAC-CE for the second PHR is associated with a second SRS resource set, the second PHR may be calculated based on the first PUSCH transmission occasion in the first slot that is overlapped with the one or more slots of the MAC-CE for the second PHR. In some aspects, the second PHR may be calculated based on the PUSCH transmission occasion that is associated with a second SRS resource set and closet to the PUSCH containing MAC-CE for the second PHR. In some aspects, the second PHR may be actual, based on Condition 2″, if a transmission occasion associated with a second SRS resource set among multi-PUSCH repetitions associated with two SRS resource sets is transmitted in the first slot that is overlapped with the one or more slots of the MAC-CE for the second PHR. In some aspects, if there are multiple transmission occasions associated with the second SRS resource set, the earliest one in slot n may be selected. Otherwise the second PHR may be reported as virtual or may not be reported.

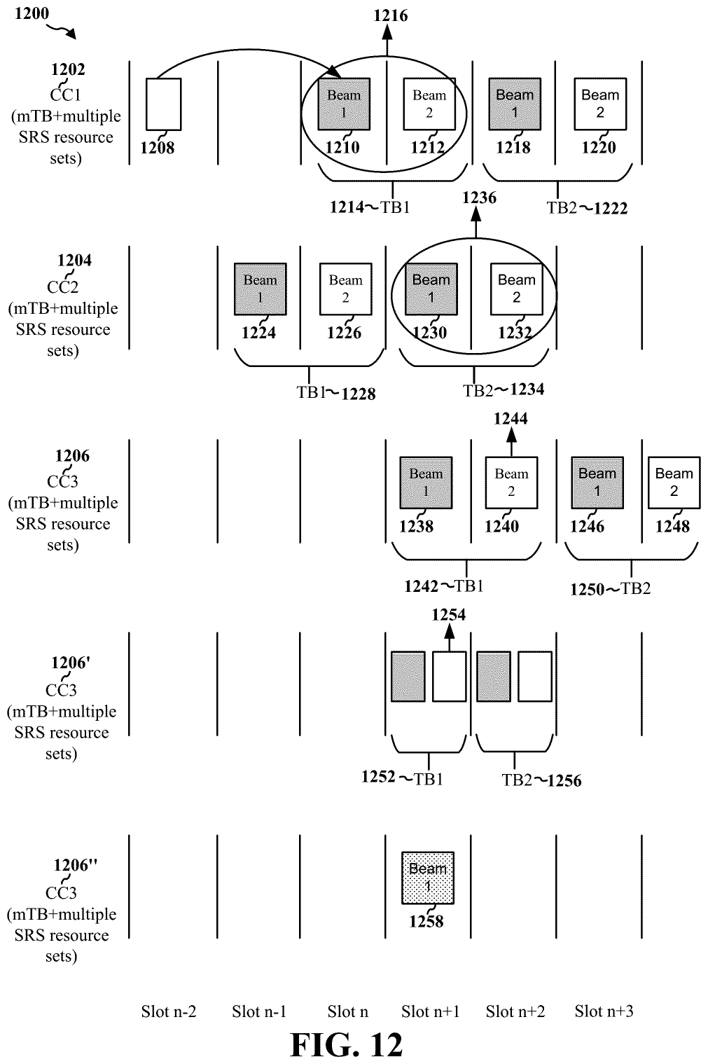

With reference to diagram 1200 of FIG. 12, a DCI 1208 may schedule a PUSCH with multiple repetitions. Repetitions 1210 and 1218 may be transmitted via Beam1, while repetitions 1212 and 1220 may be transmitted via Beam2. Repetitions 1210 and 1212 may correspond to TB1 1214 within CC1 1202, while repetitions 1218 and 1220 may correspond to TB2 1222 within CC1 1202. In CC2 1204, repetitions 1224 and 1230 may be transmitted via Beam1, while repetitions 1226 and 1232 may be transmitted via Beam2. Repetitions 1224 and 1226 may correspond to TB1 1228 within CC2 1204, while repetitions 1230 and 1232 may correspond to TB2 1234 within CC2 1204. In CC3 1206, repetitions 1238 and 1246 may be transmitted via Beam1, while repetitions 1240 and 1248 may be transmitted via Beam2. Repetitions 1238 and 1240 may correspond to TB1 1242 within CC3 1206, while repetitions 1246 and 1248 may correspond to TB2 1250 within CC3 1206. A first PUSCH 1216 may be selected to carry the first MAC-CE PHR within CC1 1202, and a second PUSCH 1236 may be selected to carry the second MAC-CE PHR within CC2 1204. The first PHR may be virtual, and the second PHR 1244 may be actual and corresponds to repetition 1240 in view of Condition 1″. In some aspects, the second PHR 1146 may be virtual in view of Condition 2″. In some aspects, for example CC3 1206′ may comprise repetitions corresponding to TB1 1252 and repetitions corresponding to TB2 1256. The first PHR may be virtual, and the second PHR 1254 may be actual and corresponds to the second repetition of TB1 1252 in view of Condition 1″ or Condition 2″. In some aspects, for example CC3 1206″ may comprise a transmission occasion 1258. The first PHR may be virtual, and the second PHR may be virtual or may not be reported.

In some aspects, if at least one CC is configured with multi-PUSCH/TB repetitions associated with multiple SRS resource sets, e.g., two SRS resource sets, in instances where PHR is triggered, the UE may select a first PUSCH to carry a first MAC-CE for the first PHR on a first CC (e.g., first PHR MAC-CE is reported in slot n). The UE may then determine a second PUSCH to carry a second MAC-CE for a second PHR based on the first PUSCH carrying the first PHR MAC-CE. For example, if the PUSCH carrying the first PHR MAC-CE corresponds to a transmission occasion among multi-PUSCH repetitions associated with two SRS resource sets (e.g., first PUSCH carrying first PHR MAC CE is part of multi-PUSCH repetitions associated with two SRS resource sets), the UE may select a second PUSCH to carry the MAC-CE for the second PHR on the same CC. The second PHR may be reported in the PHR MAC-CE on a first available PUSCH corresponding to an initial transmission of a transmission of a subsequent PUSCH/TB after PUSCH/TB for the first PHR MAC-CE that may accommodate the second MAC CE as a result of LCP. In some aspects, the first MAC-CE for the first PHR and the second MAC-CE for the second PHR may be within the same CC.

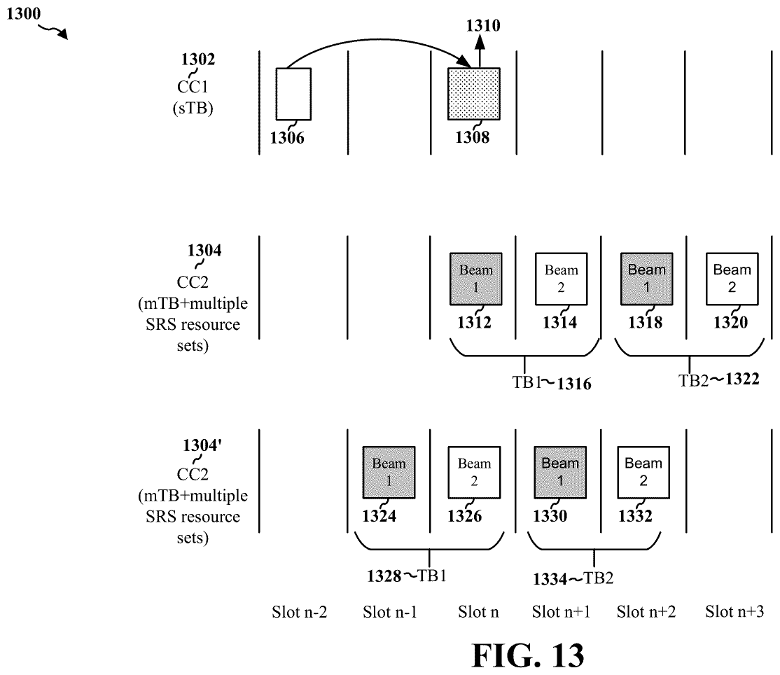

With reference to diagram 1300 of FIG. 13, a DCI 1306 may schedule PUSCH with repetitions. For example, a transmission occasion 1308 may be within CC1 1302, where CC1 1302 may be configured with a single TB. The UE may select transmission occasion 1308 for transmitting a first PUSCH 1310 carrying a first MAC-CE for a first PHR. The PUSCH 1310 may not be associated with a transmission occasion of multi-PUSCH repetitions associated with two SRS resource sets of CC2 1304 or CC2 1304′. In some aspects, CC2 1304 may comprise repetitions 1312 and 1318 that may be transmitted via Beam1, while repetitions 1314 and 1320 may be transmitted via Beam2. Repetitions 1312 and 1314 may correspond to TB1 1316, while repetitions 1318 and 1320 may correspond to TB2 1322. In some aspects CC2 1304′ may comprise repetitions 1324 and 1330 that may be transmitted via Beam1, while repetitions 1326 and 1332 may be transmitted via Beam2. Repetitions 1324 and 1326 may correspond to TB1 1328, while repetitions 1330 and 1332 may correspond to TB2 1334. However, since PUSCH 1310 does not correspond to the multi-PUSCH repetitions associated with two SRS resource sets, a second PHR is not reported.

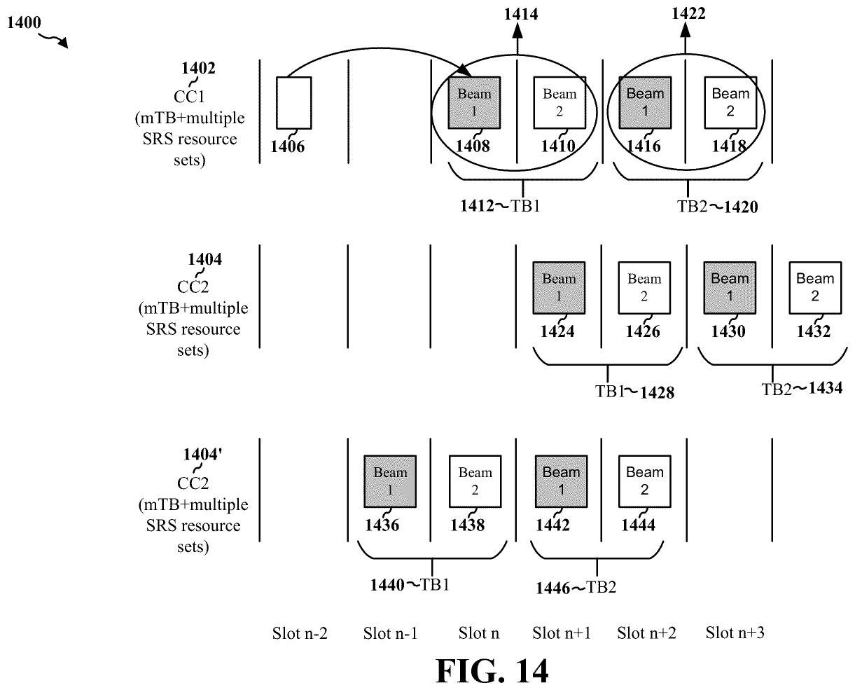

With reference to diagram 1400 of FIG. 14, a DCI 1406 may schedule multi-PUSCH repetitions. Repetitions 1408 and 1416 may be transmitted via Beam1, while repetitions 1410 and 1418 may be transmitted via Beam2. Repetitions 1408 and 1410 may correspond to TB1 1412 within CC1 1402, while repetitions 1416 and 1418 may correspond to TB2 1420 within CC1 1402. In CC2 1404, repetitions 1424 and 1430 may be transmitted via Beam1, while repetitions 1426 and 1432 may be transmitted via Beam2. Repetitions 1424 and 1426 may correspond to TB1 1428 within CC2 1404, while repetitions 1430 and 1432 may correspond to TB2 1434 within CC2 1404. In some aspects, for example CC2 1404′, may comprise repetitions 1436 and 1442 that may be transmitted via Beam1, while repetitions 1438 and 1444 may be transmitted via Beam2. Repetitions 1436 and 1438 may correspond to TB1 1440 within CC2 1404′, while repetitions 1442 and 1444 may correspond to TB2 1446 within CC2 1404′. The UE may select a first PUSCH 1414 to carry a first MAC-CE for a first PHR. The PUSCH 1414 may correspond to a repetition of multi-PUSCH repetitions associated with two SRS resource sets. The UE may select a second PUSCH 1422 to carry a second MAC-CE for a second PHR. The UE may select the second PUSCH 1422 within the same CC1 1402 based on the first PUSCH 1414 corresponding to a transmission occasion among multiple repetitions across multiple TBs associated with two SRS resource sets.

In some aspects, for example where two MAC-CE PHRs are determined based on the first PUSCH, the value of the first PHR may be based on the actual PUSCH transmission occasion. In some aspects, a CC may not be configured with multi-PUSCHs/TBs repetitions associated with multiple SRS resource sets, e.g., two SRS resource sets, and in such instances the second PHR for this CC may not be reported. If a CC is configured with multi-PUSCHs/TBs repetitions associated with multiple SRS resource sets, e.g., two SRS resource sets, the second PHR may be based on the first PHR. For example, if the first PHR value is actual and corresponds to a transmission occasion associated with a given SRS resource set among multiple repetitions across multiple TBs associated with two SRS resource set, the second PHR may be actual, under Condition 1, where there are more than one PUSCH transmission occasion associated with the other SRS resource set, the second PHR may be calculated based on at least one of whether there are other PUSCH transmission occasions associated with the other SRS resource set which transmit after the PUSCH transmission occasion used to calculate the first PHR. In such instances, the UE may select the earliest PUSCH transmission occasion. Otherwise, the UE may select the latest transmission occasion which is transmitted before the PUSCH transmission occasion used to calculate the first PHR. In some aspects, the second PHR may be actual, under Condition 2, where a transmission occasion associated with the other SRS resource set is transmitted in the first slot (e.g., slot n) that is overlapped with the one or more slots of the MAC-CE for the second PHR; otherwise the second PHR may be virtual. If there are more than one PUSCH transmission occasions associated with the other SRS resource set, the earliest one in slot n may be selected.

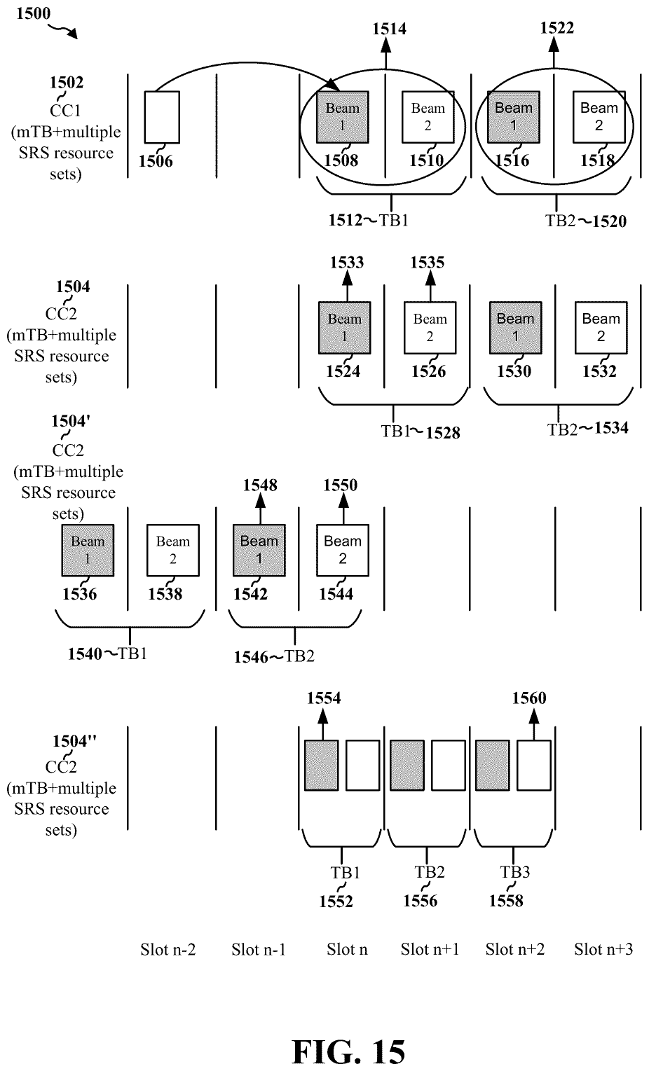

With reference to diagram 1500 of FIG. 15, a DCI 1506 may schedule multi-PUSCH repetitions. Repetitions 1508 and 1516 may be transmitted via Beam1, while repetitions 1510 and 1518 may be transmitted via Beam2. Repetitions 1508 and 1510 may correspond to TB1 1512 within CC1 1502, while repetitions 1516 and 1518 may correspond to TB2 1520 within CC1 1502. In CC2 1504, repetitions 1524 and 1530 may be transmitted via Beam1, while repetitions 1526 and 1532 may be transmitted via Beam2. Repetitions 1524 and 1526 may correspond to TB1 1528 within CC2 1504, while repetitions 1530 and 1532 may correspond to TB2 1534 within CC2 1504. In some aspects, for example CC2 1504′ may comprise repetitions 1536 and 1542 that may be transmitted via Beam1, while repetitions 1538 and 1544 may be transmitted via Beam2. Repetitions 1536 and 1538 may correspond to TB1 1540 within CC2 1504′, while repetitions 1524 and 1544 may correspond to TB2 1546 within CC2 1504′. In some aspects, for example CC2 1504″ may comprise repetitions transmitted via Beam1 or Beam2, and multiple TBs (e.g., TB1 1552, TB2 1556, TB3 1558). A first PUSCH 1514 may be selected to carry a first MAC-CE for a first PHR within CC1 1502. A second PUSCH 1522 may be selected to carry a second MAC-CE for a second PHR within CC1 1502. In some aspects, a first PHR 1533 may be actual. The value of a second PHR 1535 within CC2 1504 may be actual and corresponds to repetition 1526 in view of Condition 1, while the second PHR 1535 may be virtual or not reported in view of Condition 2. In some aspects, a first PHR 1550 may be actual. The value of a second PHR 1548 within CC2 1504′ may be actual and corresponds to repetition 1542 in view of Condition 1, while the second PHR 1548 may be virtual or not reported in view of Condition 2. In some aspects, a first PHR 1554 may be actual. The value of a second PHR 1560 within CC2 1504″ may be actual and corresponds to the second repetition of TB3 1558 in view of Condition 1 or Condition 2.

In some instances, the first PHR value may be actual but may not correspond to a transmission occasion associated with a given SRS resource set among multi-PUSCH repetitions associated with two SRS resource sets. In such instances, the second PHR may be actual if one or more of the following conditions are satisfied. For example, in Condition 1′, at least one transmission occasion associated with a given SRS resource set among multiple repetitions across multiple TBs associated with multiple SRS resource sets, e.g., two SRS resource sets is transmitted in the first slot (e.g., slot n) that is overlapped with the one or more slots of the MAC-CE for second PHR. In some aspects, if the first PUSCH transmission occasion among multi-PUSCH repetitions associated with multiple SRS resource sets, e.g., two SRS resource sets in the first slot that is overlapped with the one or more slots of the MAC-CE for the second PHR is associated with an SRS resource set that is different from the SRS resource set of the PUSCH transmission occasion for the first PHR, the second PHR may be calculated based on the first PUSCH transmission occasion in the first slot that is overlapped with the one or more slots of the MAC-CE for the second PHR. Otherwise, the second PHR may be calculated based on the PUSCH transmission occasion that is associated with an SRS resource set that is different from the SRS resource set of the PUSCH transmission occasion for the first PHR and closet to the PUSCH containing MAC-CE for second PHR. In some aspects, the second PHR may be actual, based on Condition 2′, if a transmission occasion associated with an SRS resource set among multi-PUSCH repetitions associated with multiple SRS resource sets, e.g., two SRS resource sets is transmitted in the first slot that is overlapped with the one or more slots of the MAC-CE for second PHR and the SRS resource set is different from the SRS resource set of the PUSCH transmission occasion for the first PHR. If there are multiple transmission occasions associated with the SRS resource set, the earliest one in slot n may be selected. Otherwise, the second PHR may be reported as virtual or may not be reported.

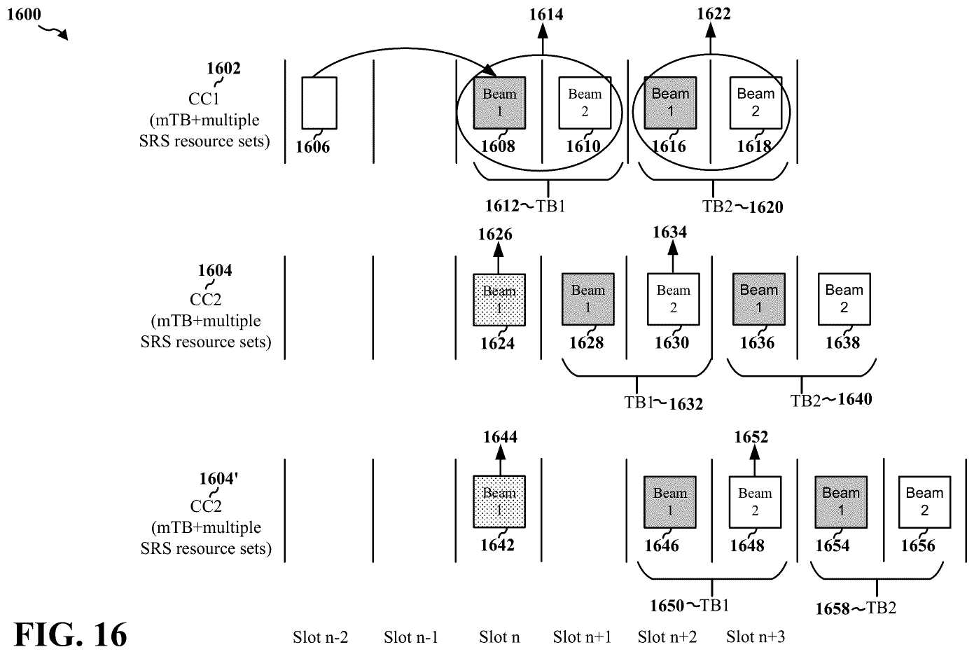

With reference to diagram 1600 of FIG. 16, a DCI 1606 may schedule multi-PUSCH repetitions. Repetitions 1608 and 1616 may be transmitted via Beam1, while repetitions 1610 and 1618 may be transmitted via Beam2. Repetitions 1608 and 1610 may correspond to TB1 1612 within CC1 1602, while repetitions 1616 and 1618 may correspond to TB2 1620 within CC1 1602. In CC2 1604, repetitions 1628 and 1636 may be transmitted via Beam1, while repetitions 1630 and 1638 may be transmitted via Beam2. Repetitions 1628 and 1630 may correspond to TB1 1632 within CC2 1604, while repetitions 1636 and 1638 may correspond to TB2 1640 within CC2 1604. CC2 1604 may further comprise transmission occasion 1624 that may be transmitted via Beam1. The transmission occasion 1624 may not correspond to the multi-PUSCH repetitions associated with two SRS resource sets. In some aspects, for example CC2 1604′ may comprise repetitions 1646 and 1654 that may be transmitted via Beam1, while repetitions 1648 and 1656 may be transmitted via Beam2. Repetitions 1646 and 1648 may correspond to TB1 1650 within CC2 1604′, while repetitions 1654 and 1656 may correspond to TB2 1658 within CC2 1604′. CC2 1604′ may further comprise transmission occasion 1642 that may be transmitted via Beam1. The transmission occasion 1642 may not correspond to the multi-PUSCH repetitions associated with two SRS resource sets. A first PUSCH 1614 may be selected to carry a first MAC-CE for a first PHR within CC1 1602. A second PUSCH 1622 may be selected to carry a second MAC-CE for a second PHR within CC1 1602. In some aspects, a first PHR 1626 may be actual. The value of the second PHR 1634 may be actual and corresponds to repetition 1630 in view of Condition 1′ or Condition 2′. In some aspects, a first PHR 1644 may be actual. The value of a second PHR 1652 may be actual and corresponds to repetition 1648 in view of Condition 1′. The value of the second PHR 1652 may be virtual or may not be reported in view of Condition 2′.

In some instances, the first PHR may be virtual. The second PHR may be actual if one or more of the following conditions are satisfied. For example, in Condition 1″, at least one transmission occasion may be associated with a second SRS resource set among multi-PUSCH repetitions associated with multiple SRS resource sets, e.g., two SRS resource sets is transmitted in the first slot (e.g., slot n) that is overlapped with the one or more slots of the MAC-CE for second PHR. In some aspects, if the first PUSCH transmission occasion among multi-PUSCH repetitions associated with multiple SRS resource sets, e.g., two SRS resource sets in the first slot that is overlapped with the one or more slots of the MAC-CE for the second PHR is associated with a second SRS resource set, the second PHR may be calculated based on the first PUSCH transmission occasion in the first slot that is overlapped with the one or more slots of the MAC-CE for the second PHR. In some aspects, the second PHR may be calculated based on the PUSCH transmission occasion that is associated with a second SRS resource set and closet to the PUSCH containing MAC-CE for the second PHR. In some aspects, the second PHR may be actual, based on Condition 2″, if a transmission occasion associated with a second SRS resource set among multi-PUSCH repetitions associated with multiple SRS resource sets, e.g., two SRS resource sets is transmitted in the first slot that is overlapped with the one or more slots of the MAC-CE for the second PHR. In some aspects, if there are multiple transmission occasions associated with the second SRS resource set, the earliest one in slot n may be selected. Otherwise the second PHR may be reported as virtual or may not be reported.

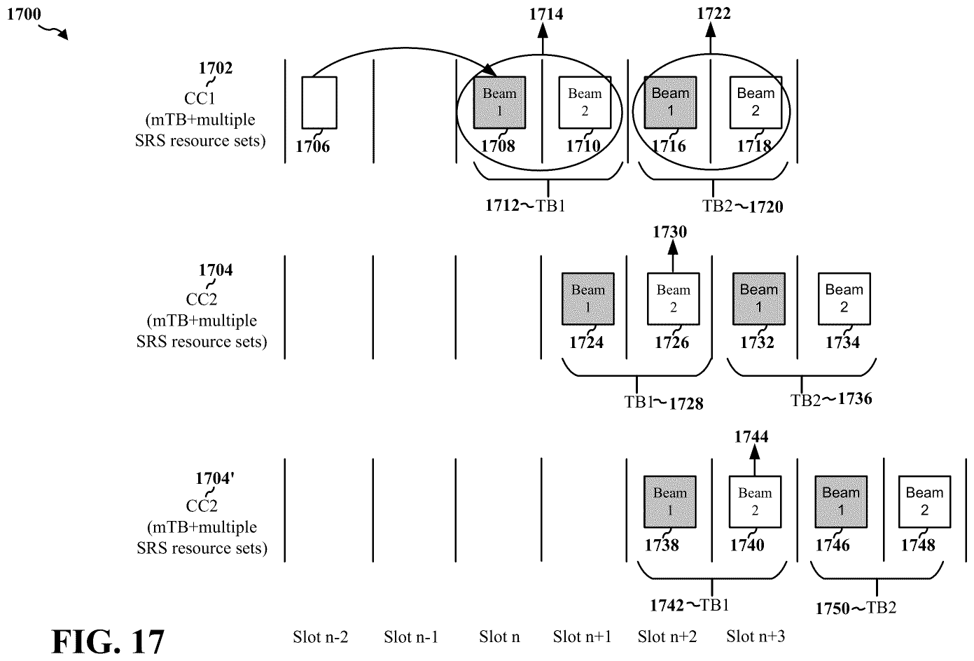

With reference to diagram 1700 of FIG. 17, a DCI 1706 may schedule multi-PUSCH repetitions. Repetitions 1708 and 1716 may be transmitted via Beam1, while repetitions 1710 and 1718 may be transmitted via Beam2. Repetitions 1708 and 1710 may correspond to TB1 1712 within CC1 1702, while repetitions 1716 and 1718 may correspond to TB2 1720 within CC1 1702. In CC2 1704, repetitions 1724 and 1732 may be transmitted via Beam1, while repetitions 1726 and 1734 may be transmitted via Beam2. Repetitions 1724 and 1726 may correspond to TB1 1728 within CC2 1704, while repetitions 1732 and 1734 may correspond to TB2 1736 within CC2 1704. In some aspects, for example CC2 1704′ may comprise repetitions 1738 and 1746 that may be transmitted via Beam1, while repetitions 1740 and 1748 may be transmitted via Beam2. Repetitions 1738 and 1740 may correspond to TB1 1712 within CC2 1704′, while repetitions 1746 and 1748 may correspond to TB2 1750 within CC2 1604′. A first PUSCH 1714 may be selected to carry a first MAC-CE for a first PHR within CC1 1702. A second PUSCH 1722 may be selected to carry a second MAC-CE for a second PHR within CC1 1602. In some aspects, the first PHR may be virtual and the second PHR 1730 may be actual and corresponds to repetition 1726 in view of Condition 1″ or Condition 2″. In some aspects, the first PHR may be virtual and the second PHR 1744 may be actual and corresponds to repetition 1740 in view of Condition 1″, while the second PHR 1744 may be virtual or may not be reported in view of Condition 2″.

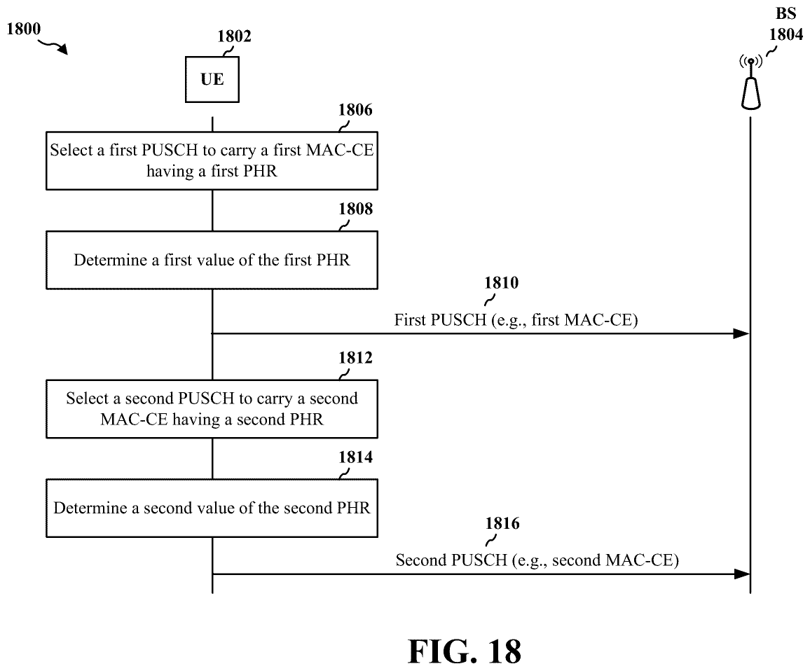

FIG. 18 is a call flow diagram 1800 of signaling between a UE 1802 and a base station 1804. The base station 1804 may be configured to provide at least one cell. The UE 1802 may be configured to communicate with the base station 1804. For example, in the context of FIG. 1, the base station 1804 may correspond to base station 102/180 and, accordingly, the cell may include a geographic coverage area 110 in which communication coverage is provided and/or small cell 102′ having a coverage area 110′. Further, a UE 1802 may correspond to at least UE 104. In another example, in the context of FIG. 3, the base station 1804 may correspond to base station 310 and the UE 1802 may correspond to UE 350.

As illustrated at 1806, the UE 1802 may select a first PUSCH to carry a first MAC-CE having a first PHR. In some aspects, the first PUSCH may be on a first component carrier (CC). In some aspects, the first PHR may be carried on the first MAC-CE on a first available PUSCH. The first available PUSCH may correspond to an initial transmission of a first transport block (TB) that accommodates the first MAC-CE.

As illustrated at 1808, the UE 1802 may determine a first value of the first PHR. The UE may determine the first value of the first PHR based on a third PUSCH (not shown). In some aspects, the first value of the first PHR may comprise at least one of a first actual value or a first virtual value. The first value of the first PHR may comprise the first actual value if the first PHR corresponds to an actual PUSCH transmission occasion. The first value of the first PHR may comprise the first virtual value if the first PHR corresponds to a reference PUSCH transmission. The UE 1802, at 1810, may transmit the first PUSCH comprising the first MAC-CE. The UE 1802 may transmit the first PUSCH comprising the first MAC-CE to the base station 1804. The base station 1804 may receive the first PUSCH comprising the first MAC-CE from the UE 1802.

As illustrated at 1812, the UE 1802 may select a second PUSCH to carry a second MAC-CE having a second PHR. The UE may select the second PUSCH to carry the second MAC-CE having the second PHR based on the third PUSCH or the first PUSCH. In some aspects, the second PUSCH may be selected on a second CC if the first value of the first PHR comprises a first actual value and the third PUSCH corresponds to an actual PUSCH transmission occasion associated with a given sounding reference signal (SRS) resource set among multi-PUSCH repetitions associated with a plurality of SRS resource sets, e.g., two SRS resource sets. The second PHR may be carried on the second MAC-CE on a first available PUSCH corresponding to an initial transmission of a second TB that may accommodate the second MAC-CE. In some aspects, the first PUSCH and the second PUSCH may be on a same CC. In some aspects, the second PUSCH may be selected to carry the second PHR if the first PUSCH corresponds to a PUSCH transmission occasion associated with a SRS resource set among multi-PUSCH repetitions associated with a plurality of SRS resource sets, e.g., two SRS resource sets. The second PHR may be carried on the second MAC-CE on a first available PUSCH corresponding to an initial transmission of a second TB that may accommodate the second MAC-CE.

As illustrated at 1814, the UE 1802 may determine a second value of the second PHR. The UE may determine the second value of the second PHR based on a fourth PUSCH. In some aspects, the second value of the second PHR may comprise a second actual value if the first value of the first PHR comprises a first actual value corresponding to a PUSCH transmission occasion associated with a first SRS resource set among multi-PUSCH repetitions associated with a plurality of SRS resource sets, e.g., two SRS resource sets. An earliest PUSCH transmission occasion from PUSCH transmission occasions associated with a second SRS resource set that occurs after the PUSCH transmission occasion used to calculate the first value of the first PHR may be selected as the fourth PUSCH. A latest PUSCH transmission occasion that is transmitted before the PUSCH transmission occasion used to calculate the first value of the first PHR may be selected as the fourth PUSCH. In some aspects, the second value of the second PHR may comprise a second actual value if the first value of the first PHR comprises a first actual value that corresponds to a PUSCH transmission occasion associated with a first SRS resource set among multi-PUSCH repetitions associated with a plurality of SRS resource sets, e.g., two SRS resource sets. An earliest PUSCH transmission occasion associated with a second SRS resource set in a first slot that overlaps with one or more slots of the second MAC-CE for the second PHR may be selected as the fourth PUSCH.

In some aspects, the second value of the second PHR may comprise a second actual value if the first value of the first PHR comprises a first actual value and does not correspond to a PUSCH transmission occasion associated with a first SRS resource set among multi-PUSCH repetitions associated with a plurality of SRS resource sets, e.g., two SRS resource sets, and if at least one transmission occasion associated with a SRS resource set among the multi-PUSCH repetitions associated with the plurality of SRS resource sets, e.g., two SRS resource sets is transmitted in a first slot that is overlapped with one or more slots of the second MAC-CE for the second PHR. The second value of the second PHR may be based on a first PUSCH transmission occasion in a first slot that may be overlapped with the one or more slots of the second MAC-CE for the second PHR. The second value of the second PHR may be based on the PUSCH transmission occasion that is associated with an SRS resource set that is different from the SRS resource set of the PUSCH transmission occasion for the first PHR and is closest to the second PUSCH.

In some aspects, the second value of the second PHR may comprise a second actual value if the first value of the first PHR comprises a first actual value and does not correspond to a PUSCH transmission occasion associated with a first SRS resource set among multi-PUSCH repetitions associated with a plurality of SRS resource sets, e.g., two SRS resource sets, and if at least one transmission occasion associated with a second SRS resource set among the multi-PUSCH repetitions associated with the plurality of SRS resource sets is transmitted in a first slot that is overlapped with one or more slots of the second MAC-CE for the second PHR and the second SRS resource set that is different from the first SRS resource set of the PUSCH transmission occasion for the first PHR. The second value of the second PHR may be based on an earliest PUSCH transmission occasion associated with the second SRS resource set in a first slot that overlaps with the one or more slots of the second MAC-CE for the second PHR. In some aspects, the second value of the second PHR may comprise a second actual value if the first value of the first PHR comprises a first virtual value, and if at least one transmission occasion associated with a SRS resource set among multi-PUSCH repetitions associated with a plurality of SRS resource sets, e.g., two SRS resource sets is transmitted in a first slot that is overlapped with one or more slots of the second MAC-CE for the second PHR. The second value of the second PHR may be based on a first PUSCH transmission occasion that is associated with a second SRS resource set in a first slot that is overlapped with the one or more slots of the second MAC-CE for the second PHR. The second value of the second PHR may be based on a PUSCH transmission occasion that is associated with a second SRS resource set and closest to the second PUSCH.

In some aspects, the second value of the second PHR may comprise a first actual value if the first value of the first PHR comprises a first virtual value, and if at least one transmission occasion associated with a second SRS resource set among multi-repetitions associated with a plurality of SRS resource sets, e.g., two SRS resource sets is transmitted in a first slot that is overlapped with one or more slots of the second MAC-CE for the second PHR and the second SRS resource set that is different from a first SRS resource set of a PUSCH transmission occasion for the first PHR. An earliest PUSCH transmission occasion from a plurality of PUSCH transmission occasions associated with the second SRS resource set may be selected for the fourth PUSCH.

The UE 1802, at 1816, may transmit the second PUSCH comprising the second MAC-CE. The UE 1802 may transmit the second PUSCH comprising the second MAC-CE to the base station 1804. The base station 1804 may receive the second PUSCH comprising the second MAC-CE from the UE 1802.

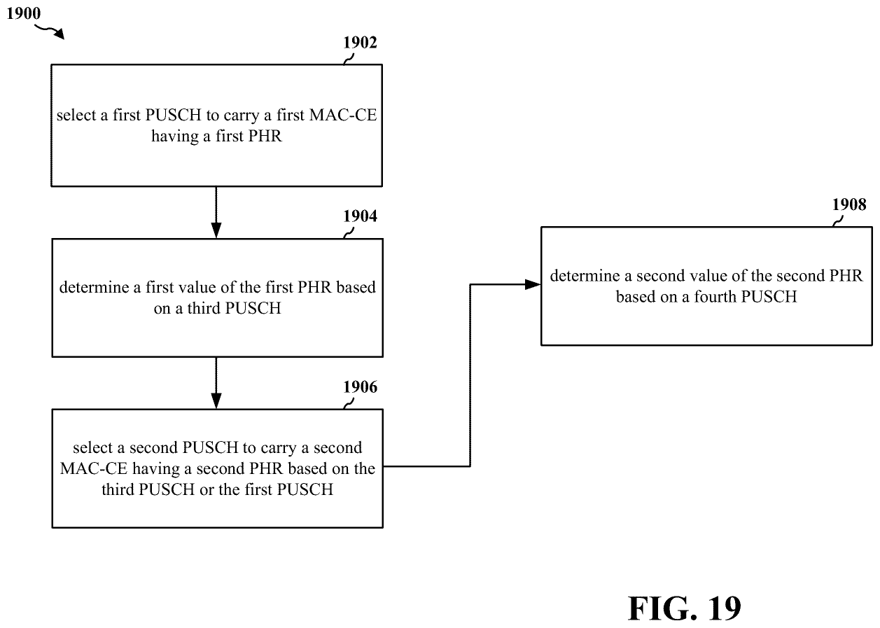

FIG. 19 is a flowchart 1900 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to determine at least one PUSCH to carry a MAC-CE for PHR.

At 1902, the UE may select a first PUSCH to carry a first MAC-CE having a first PHR. For example, 1902 may be performed by selection component 2040 of apparatus 2002. In some aspects, the first PUSCH may be on a first CC. In some aspects, the first PHR may be carried on the first MAC-CE on a first available PUSCH. The first available PUSCH may correspond to an initial transmission of a first TB that accommodates the first MAC-CE.

At 1904, the UE may determine a first value of the first PHR. For example, 1904 may be performed by value component 2042 of apparatus 2002. The UE may determine the first value of the first PHR based on a third PUSCH. In some aspects, the first value of the first PHR may comprise at least one of a first actual value or a first virtual value. The first value of the first PHR may comprise the first actual value if the first PHR corresponds to an actual PUSCH transmission occasion. The first value of the first PHR may comprise the first virtual value if the first PHR corresponds to a reference PUSCH transmission.

At 1906, the UE may select a second PUSCH to carry a second MAC-CE having a second PHR. For example, 1906 may be performed by selection component 2040 of apparatus 2002. The UE may select the second PUSCH to carry the second MAC-CE having the second PHR based on the third PUSCH or the first PUSCH. In some aspects, the second PUSCH may be selected on a second CC if the first value of the first PHR comprises a first actual value and the third PUSCH corresponds to an actual PUSCH transmission occasion associated with a given SRS resource set among multi-PUSCH repetitions associated with a plurality of SRS resource sets, e.g., two SRS resource sets. The second PHR may be carried on the second MAC-CE on a first available PUSCH corresponding to an initial transmission of a second TB that may accommodate the second MAC-CE. In some aspects, the first PUSCH and the second PUSCH may be on a same CC. In some aspects, the second PUSCH may be selected to carry the second PHR if the first PUSCH corresponds to a PUSCH transmission occasion associated with a SRS resource set among multi-PUSCH repetitions associated with a plurality of SRS resource sets, e.g., two SRS resource sets. The second PHR may be carried on the second MAC-CE on a first available PUSCH corresponding to an initial transmission of a second TB that may accommodate the second MAC-CE.

At 1908, the UE may determine a second value of the second PHR. For example, 1908 may be performed by value component 2042 of apparatus 2002. The UE may determine the second value of the second PHR based on a fourth PUSCH. In some aspects, the second value of the second PHR may comprise a second actual value if the first value of the first PHR comprises a first actual value corresponding to a PUSCH transmission occasion associated with a first SRS resource set among multi-PUSCH repetitions associated with a plurality of SRS resource sets, e.g., two SRS resource sets. An earliest PUSCH transmission occasion from PUSCH transmission occasions associated with a second SRS resource set that occurs after the PUSCH transmission occasion used to calculate the first value of the first PHR may be selected as the fourth PUSCH. A latest PUSCH transmission occasion that is transmitted before the PUSCH transmission occasion used to calculate the first value of the first PHR may be selected as the fourth PUSCH. In some aspects, the second value of the second PHR may comprise a second actual value if the first value of the first PHR comprises a first actual value that corresponds to a PUSCH transmission occasion associated with a first SRS resource set among multi-PUSCH repetitions associated with a plurality of SRS resource sets, e.g., two SRS resource sets. An earliest PUSCH transmission occasion associated with a second SRS resource set in a first slot that overlaps with one or more slots of the second MAC-CE for the second PHR may be selected as the fourth PUSCH. In some aspects, the second value of the second PHR may comprise a second actual value if the first value of the first PHR comprises a first actual value and does not correspond to a PUSCH transmission occasion associated with a first SRS resource set among multi-PUSCH repetitions associated with a plurality of SRS resource sets, and if at least one transmission occasion associated with a SRS resource set among the multi-PUSCH repetitions associated with the plurality of SRS resource sets, e.g., two SRS resource sets is transmitted in a first slot that is overlapped with one or more slots of the second MAC-CE for the second PHR. The second value of the second PHR may be based on a first PUSCH transmission occasion in a first slot that may be overlapped with the one or more slots of the second MAC-CE for the second PHR. The second value of the second PHR may be based on the PUSCH transmission occasion that is associated with an SRS resource set that is different from the SRS resource set of the PUSCH transmission occasion for the first PHR and is closest to the second PUSCH. In some aspects, the second value of the second PHR may comprise a second actual value if the first value of the first PHR comprises a first actual value and does not correspond to a PUSCH transmission occasion associated with a first SRS resource set among multi-PUSCH repetitions associated with a plurality of SRS resource sets, and if at least one transmission occasion associated with a second SRS resource set among the multi-PUSCH repetitions associated with the plurality of SRS resource sets, e.g., two SRS resource sets is transmitted in a first slot that is overlapped with one or more slots of the second MAC-CE for the second PHR and the second SRS resource set that is different from the first SRS resource set of the PUSCH transmission occasion for the first PHR. The second value of the second PHR may be based on an earliest PUSCH transmission occasion associated with the second SRS resource set in a first slot that overlaps with the one or more slots of the second MAC-CE for the second PHR. In some aspects, the second value of the second PHR may comprise a second actual value if the first value of the first PHR comprises a first virtual value, and if at least one transmission occasion associated with a SRS resource set among multi-PUSCH repetitions associated with a plurality of SRS resource sets, e.g., two SRS resource sets is transmitted in a first slot that is overlapped with one or more slots of the second MAC-CE for the second PHR. The second value of the second PHR may be based on a first PUSCH transmission occasion that is associated with a second SRS resource set in a first slot that is overlapped with the one or more slots of the second MAC-CE for the second PHR. The second value of the second PHR may be based on a PUSCH transmission occasion that is associated with a second SRS resource set and closest to the second PUSCH. In some aspects, the second value of the second PHR may comprise a first actual value if the first value of the first PHR comprises a first virtual value, and if at least one transmission occasion associated with a second SRS resource set among multi-PUSCH repetitions associated with a plurality of SRS resource sets is transmitted in a first slot that is overlapped with one or more slots of the second MAC-CE for the second PHR and the second SRS resource set that is different from a first SRS resource set of a PUSCH transmission occasion for the first PHR. An earliest PUSCH transmission occasion from a plurality of PUSCH transmission occasions associated with the second SRS resource set may be selected for the fourth PUSCH.

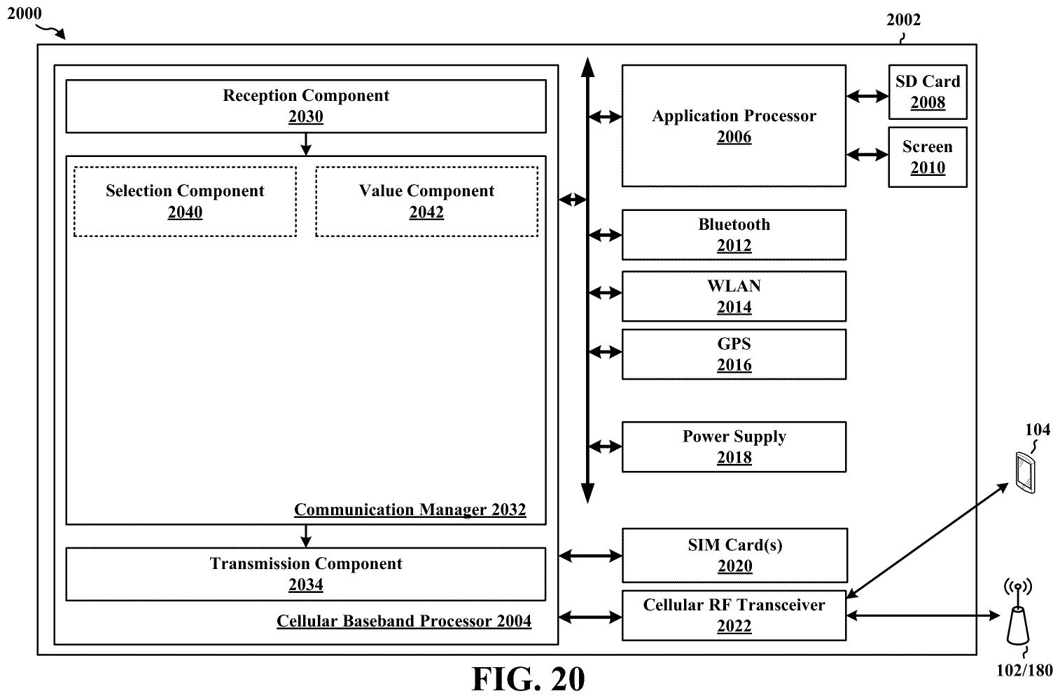

FIG. 20 is a diagram 2000 illustrating an example of a hardware implementation for an apparatus 2002. The apparatus 2002 may be a UE, a component of a UE, or may implement UE functionality. In some aspects, the apparatus 2002 may include a cellular baseband processor 2004 (also referred to as a modem) coupled to a cellular RF transceiver 2022. In some aspects, the apparatus 2002 may further include one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, or a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359. In one configuration, the apparatus 2002 may be a modem chip and include just the baseband processor 2004, and in another configuration, the apparatus 2002 may be the entire UE (e.g., see 350 of FIG. 3) and include the additional modules of the apparatus 2002.

The communication manager 2032 includes a selection component 2040 that is configured to select a first PUSCH to carry a first MAC-CE having a first PHR, e.g., as described in connection with 1902 of FIG. 19. The selection component 2040 may be further configured to select a second PUSCH to carry a second MAC-CE having a second PHR, e.g., as described in connection with 1906 of FIG. 19. The communication manager 2032 further includes a value component 2042 that is configured to determine a first value of the first PHR, e.g., as described in connection with 1904 of FIG. 19. The value component 2042 may be further configured to determine a second value of the second PHR, e.g., as described in connection with 1908 of FIG. 19.

The apparatus may include additional components that perform each of the blocks of the algorithm in the flowchart of FIG. 19. As such, each block in the flowchart of FIG. 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the cellular baseband processor 2004, includes means for selecting a first PUSCH to carry a first MAC-CE having a first PHR. The apparatus includes means for determining a first value of the first PHR based on a third PUSCH. The apparatus includes means for selecting a second PUSCH to carry a second MAC-CE having a second PHR based on the third PUSCH or the first PUSCH. The apparatus includes means for determining a second value of the second PHR based on a fourth PUSCH. The means may be one or more of the components of the apparatus 2002 configured to perform the functions recited by the means. As described supra, the apparatus 2002 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to select a first PUSCH to carry a first MAC-CE having a first PHR; determine a first value of the first PHR based on a third PUSCH; select a second PUSCH to carry a second MAC-CE having a second PHR based on the third PUSCH or the first PUSCH; and determine a second value of the second PHR based on a fourth PUSCH.

Aspect 2 is the apparatus of aspect 1, further including a transceiver coupled to the at least one processor.

Aspect 3 is the apparatus of any of aspects 1 and 2, further includes that the first PUSCH is on a first CC.

Aspect 4 is the apparatus of any of aspects 1-3, further includes that the first PHR is carried on the first MAC-CE on a first available PUSCH.

Aspect 5 is the apparatus of any of aspects 1-4, further includes that the first available PUSCH corresponds to an initial transmission of a first TB that accommodates the first MAC-CE.

Aspect 6 is the apparatus of any of aspects 1-5, further includes that the first value of the first PHR comprises at least one of a first actual value or a first virtual value.

Aspect 7 is the apparatus of any of aspects 1-6, further includes that the first value of the first PHR comprises the first actual value if the first PHR corresponds to an actual PUSCH transmission occasion.

Aspect 8 is the apparatus of any of aspects 1-7, further includes that the first value of the first PHR comprises the first virtual value if the first PHR corresponds to a reference PUSCH transmission.

Aspect 9 is the apparatus of any of aspects 1-8, further includes that the second PUSCH is selected on a second CC if the first value of the first PHR comprises a first actual value and the third PUSCH corresponds to an actual PUSCH transmission occasion associated with a given SRS resource set among multiple PUSCH repetitions of multiple TBs associated with a plurality of SRS resource sets.

Aspect 10 is the apparatus of any of aspects 1-9, further includes that the second PHR is carried on the second MAC-CE on a first available PUSCH corresponding to an initial transmission of a second TB that accommodates the second MAC-CE.

Aspect 11 is the apparatus of any of aspects 1-10, further includes that the first PUSCH and the second PUSCH are on a same CC.

Aspect 12 is the apparatus of any of aspects 1-11, further includes that the second PUSCH is selected to carry the second PHR if the first PUSCH corresponds to a PUSCH transmission occasion associated with a SRS resource set among multiple PUSCH repetitions of multiple TBs associated with a plurality of SRS resource sets.

Aspect 13 is the apparatus of any of aspects 1-12, further includes that the second PHR is carried on the second MAC-CE on a first available PUSCH corresponding to an initial transmission of a second TB that accommodates the second MAC-CE.

Aspect 14 is the apparatus of any of aspects 1-13, further includes that the second value of the second PHR comprises a second actual value if the first value of the first PHR comprises a first actual value corresponding to a PUSCH transmission occasion associated with a first SRS resource set among multiple PUSCH repetitions of multiple TBs associated with a plurality of SRS resource sets, wherein an earliest PUSCH transmission occasion from PUSCH transmission occasions associated with a second SRS resource set that occurs after the PUSCH transmission occasion used to calculate the first value of the first PHR is selected as the fourth PUSCH, or wherein a latest PUSCH transmission occasion that is transmitted before the PUSCH transmission occasion used to calculate the first value of the first PHR is selected as the fourth PUSCH.

Aspect 15 is the apparatus of any of aspects 1-14, further includes that the second value of the second PHR comprises a second actual value if the first value of the first PHR comprises a first actual value corresponding to a PUSCH transmission occasion associated with a first SRS resource set among multiple PUSCH repetitions of multiple TBs associated with a plurality of SRS resource sets, wherein an earliest PUSCH transmission occasion associated with a second SRS resource set in a first slot that overlaps with one or more slots of the second MAC-CE for the second PHR is selected as the fourth PUSCH.

Aspect 16 is the apparatus of any of aspects 1-15, further includes that the second value of the second PHR comprises a second actual value if the first value of the first PHR comprises a first actual value and does not correspond to a PUSCH transmission occasion associated with a first SRS resource set among multiple PUSCH repetitions of multiple TBs associated with a plurality of SRS resource sets, and if at least one transmission occasion associated with a SRS resource set among the multiple PUSCH repetitions of the multiple TBs associated with the plurality of SRS resource sets is transmitted in a first slot that is overlapped with one or more slots of the second MAC-CE for the second PHR, wherein the second value of the second PHR is based on a first PUSCH transmission occasion in a first slot that is overlapped with the one or more slots of the second MAC-CE for the second PHR, or wherein the second value of the second PHR is based on the PUSCH transmission occasion that is associated with an SRS resource set that is different from the SRS resource set of the PUSCH transmission occasion for the first PHR and is closest to the second PUSCH.

Aspect 17 is the apparatus of any of aspects the second value of the second PHR comprises a second actual value if the first value of the first PHR comprises a first actual value and does not correspond to a PUSCH transmission occasion associated with a first SRS resource set among multiple PUSCH repetitions of multiple TBs associated with a plurality of SRS resource sets, and if at least one transmission occasion associated with a second SRS resource set among the multiple PUSCH repetitions of the multiple TBs associated with the plurality of SRS resource sets is transmitted in a first slot that is overlapped with one or more slots of the second MAC-CE for the second PHR and the second SRS resource set that is different from the first SRS resource set of the PUSCH transmission occasion for the first PHR, wherein the second value of the second PHR is based on an earliest PUSCH transmission occasion associated with the second SRS resource set in a first slot that overlaps with the one or more slots of the second MAC-CE for the second PHR.

Aspect 18 is the apparatus of any of aspects 1-17, further includes that the second value of the second PHR comprises a second actual value if the first value of the first PHR comprises a first virtual value, and if at least one transmission occasion associated with a SRS resource set among multiple PUSCH repetitions of multiple TBs associated with a plurality of SRS resource sets is transmitted in a first slot that is overlapped with one or more slots of the second MAC-CE for the second PHR, wherein the second value of the second PHR is based on a first PUSCH transmission occasion that is associated with a second SRS resource set in a first slot that is overlapped with the one or more slots of the second MAC-CE for the second PHR, or wherein the second value of the second PHR is based on a PUSCH transmission occasion that is associated with a second SRS resource set and closest to the second PUSCH.

Aspect 19 is the apparatus of any of aspects 1-18, further includes that the second value of the second PHR comprises a first actual value if the first value of the first PHR comprises a first virtual value, and if at least one transmission occasion associated with a second SRS resource set among multiple repetitions of multiple TBs associated with a plurality of SRS resource sets is transmitted in a first slot that is overlapped with one or more slots of the second MAC-CE for the second PHR and the second SRS resource set that is different from a first SRS resource set of a PUSCH transmission occasion for the first PHR, or wherein an earliest PUSCH transmission occasion from a plurality of PUSCH transmission occasions associated with the second SRS resource set is selected for the fourth PUSCH.

Aspect 20 is a method of wireless communication for implementing any of aspects 1-19.

Aspect 21 is an apparatus for wireless communication including means for implementing any of aspects 1-19.

Aspect 22 is a computer-readable medium storing computer executable code, where the code when executed by a processor causes the processor to implement any of aspects 1-19.

What is claimed is:

1. An apparatus for wireless communication at a user equipment (UE), comprising:
a memory; and
at least one processor coupled to the memory and configured to:
select a first physical uplink shared channel (PUSCH) to carry a first medium access control (MAC) control element (CE) (MAC-CE) having a first power headroom report (PHR);
determine a first value of the first PHR based on a third PUSCH;
select a second PUSCH to carry a second MAC-CE having a second PHR based on the third PUSCH or the first PUSCH; and
determine a second value of the second PHR based on a fourth PUSCH.

2. The apparatus of claim 1, further comprising a transceiver coupled to the at least one processor.

3. The apparatus of claim 1, wherein the first PUSCH is on a first component carrier (CC).

4. The apparatus of claim 1, wherein the first PHR is carried on the first MAC-CE on a first available PUSCH.

5. The apparatus of claim 4, wherein the first available PUSCH corresponds to an initial transmission of a first transport block (TB) that accommodates the first MAC-CE.

6. The apparatus of claim 1, wherein the first value of the first PHR comprises at least one of a first actual value or a first virtual value.

7. The apparatus of claim 6, wherein the first value of the first PHR comprises the first actual value if the first PHR corresponds to an actual PUSCH transmission occasion.

8. The apparatus of claim 6, wherein the first value of the first PHR comprises the first virtual value if the first PHR corresponds to a reference PUSCH transmission.

9. The apparatus of claim 1, wherein the second PUSCH is selected on a second component carrier (CC) if the first value of the first PHR comprises a first actual value and the third PUSCH corresponds to an actual PUSCH transmission occasion associated with a given sounding reference signal (SRS) resource set among multiple PUSCH repetitions of multiple transport blocks (TBs) associated with a plurality of SRS resource sets.

10. The apparatus of claim 9, wherein the second PHR is carried on the second MAC-CE on a first available PUSCH corresponding to an initial transmission of a second TB that accommodates the second MAC-CE.

11. The apparatus of claim 1, wherein the first PUSCH and the second PUSCH are on a same component carrier (CC).

12. The apparatus of claim 1, wherein the second PUSCH is selected to carry the second PHR if the first PUSCH corresponds to a PUSCH transmission occasion associated with a sounding reference signal (SRS) resource set among multiple PUSCH repetitions of multiple transport blocks (TBs) associated with a plurality of SRS resource sets.

13. The apparatus of claim 11, wherein the second PHR is carried on the second MAC-CE on a first available PUSCH corresponding to an initial transmission of a second TB that accommodates the second MAC-CE.

14. The apparatus of claim 1, wherein the second value of the second PHR comprises a second actual value if the first value of the first PHR comprises a first actual value corresponding to a PUSCH transmission occasion associated with a first sounding reference signal (SRS) resource set among multiple PUSCH repetitions of multiple transport blocks (TBs) associated with a plurality of SRS resource sets,
wherein an earliest PUSCH transmission occasion from PUSCH transmission occasions associated with a second SRS resource set that occurs after the PUSCH transmission occasion used to calculate the first value of the first PHR is selected as the fourth PUSCH, or
wherein a latest PUSCH transmission occasion that is transmitted before the PUSCH transmission occasion used to calculate the first value of the first PHR is selected as the fourth PUSCH.

15. The apparatus of claim 1, wherein the second value of the second PHR comprises a second actual value if the first value of the first PHR comprises a first actual value corresponding to a PUSCH transmission occasion associated with a first sounding reference signal (SRS) resource set among multiple PUSCH repetitions of multiple transport blocks (TBs) associated with a plurality of SRS resource sets,
wherein an earliest PUSCH transmission occasion associated with a second SRS resource set in a first slot that overlaps with one or more slots of the second MAC-CE for the second PHR is selected as the fourth PUSCH.

16. The apparatus of claim 1, wherein the second value of the second PHR comprises a second actual value if the first value of the first PHR comprises a first actual value and does not correspond to a PUSCH transmission occasion associated with a first sounding reference signal (SRS) resource set among multiple PUSCH repetitions of multiple transport blocks (TBs) associated with a plurality of SRS resource sets, and if at least one transmission occasion associated with a SRS resource set among the multiple PUSCH repetitions of the multiple TBs associated with the plurality of SRS resource sets is transmitted in a first slot that is overlapped with one or more slots of the second MAC-CE for the second PHR,
wherein the second value of the second PHR is based on a first PUSCH transmission occasion in a first slot that is overlapped with the one or more slots of the second MAC-CE for the second PHR, or
wherein the second value of the second PHR is based on the PUSCH transmission occasion that is associated with an SRS resource set that is different from the SRS resource set of the PUSCH transmission occasion for the first PHR and is closest to the second PUSCH.

17. The apparatus of claim 1, wherein the second value of the second PHR comprises a second actual value if the first value of the first PHR comprises a first actual value and does not correspond to a PUSCH transmission occasion associated with a first sounding reference signal (SRS) resource set among multiple PUSCH repetitions of multiple transport blocks (TBs) associated with a plurality of SRS resource sets, and if at least one transmission occasion associated with a second SRS resource set among the multiple PUSCH repetitions of the multiple TBs associated with the plurality of SRS resource sets is transmitted in a first slot that is overlapped with one or more slots of the second MAC-CE for the second PHR and the second SRS resource set that is different from the first SRS resource set of the PUSCH transmission occasion for the first PHR,
wherein the second value of the second PHR is based on an earliest PUSCH transmission occasion associated with the second SRS resource set in a first slot that overlaps with the one or more slots of the second MAC-CE for the second PHR.

18. The apparatus of claim 1, wherein the second value of the second PHR comprises a second actual value if the first value of the first PHR comprises a first virtual value, and if at least one transmission occasion associated with a sounding reference signal (SRS) resource set among multiple PUSCH repetitions of multiple transport blocks (TBs) associated with a plurality of SRS resource sets is transmitted in a first slot that is overlapped with one or more slots of the second MAC-CE for the second PHR,
wherein the second value of the second PHR is based on a first PUSCH transmission occasion that is associated with a second SRS resource set in a first slot that is overlapped with the one or more slots of the second MAC-CE for the second PHR, or
wherein the second value of the second PHR is based on a PUSCH transmission occasion that is associated with a second sounding reference signal (SRS) resource set and closest to the second PUSCH.

19. The apparatus of claim 1, wherein the second value of the second PHR comprises a first actual value if the first value of the first PHR comprises a first virtual value, and if at least one transmission occasion associated with a second sounding reference signal (SRS) resource set among multiple repetitions of multiple transport blocks (TBs) associated with a plurality of SRS resource sets is transmitted in a first slot that is overlapped with one or more slots of the second MAC-CE for the second PHR and the second SRS resource set that is different from a first SRS resource set of a PUSCH transmission occasion for the first PHR, or
wherein an earliest PUSCH transmission occasion from a plurality of PUSCH transmission occasions associated with the second SRS resource set is selected for the fourth PUSCH.

20. A method of wireless communication at a user equipment (UE), comprising:
selecting a first physical uplink shared channel (PUSCH) to carry a first medium access control (MAC) control element (CE) (MAC-CE) having a first power headroom report (PHR);
determining a first value of the first PHR based on a third PUSCH;
selecting a second PUSCH to carry a second MAC-CE having a second PHR based on the third PUSCH or the first PUSCH; and
determining a second value of the second PHR based on a fourth PUSCH.

21. The method of claim 20, wherein the first PUSCH is on a first component carrier (CC).

22. The method of claim 20, wherein the first PHR is carried on the first MAC-CE on a first available PUSCH.

23. The method of claim 22, wherein the first available PUSCH corresponds to an initial transmission of a first transport block (TB) that accommodates the first MAC-CE.

24. The method of claim 20, wherein the first value of the first PHR comprises at least one of a first actual value or a first virtual value.

25. The method of claim 24, wherein the first value of the first PHR comprises the first actual value if the first PHR corresponds to an actual PUSCH transmission occasion.

26. The method of claim 24, wherein the first value of the first PHR comprises the first virtual value if the first PHR corresponds to a reference PUSCH transmission.

27. The method of claim 20, wherein the second PUSCH is selected on a second component carrier (CC) if the first value of the first PHR comprises a first actual value and the third PUSCH corresponds to an actual PUSCH transmission occasion associated with a given sounding reference signal (SRS) resource set among multiple PUSCH repetitions of multiple transport blocks (TBs) associated with a plurality of SRS resource sets.

28. The method of claim 27, wherein the second PHR is carried on the second MAC-CE on a first available PUSCH corresponding to an initial transmission of a second TB that accommodates the second MAC-CE.

29. An apparatus for wireless communication at a user equipment (UE), comprising:
means for selecting a first physical uplink shared channel (PUSCH) to carry a first medium access control (MAC) control element (CE) (MAC-CE) having a first power headroom report (PHR);
means for determining a first value of the first PHR based on a third PUSCH;
means for selecting a second PUSCH to carry a second MAC-CE having a second PHR based on the third PUSCH or the first PUSCH; and
means for determining a second value of the second PHR based on a fourth PUSCH.

30. A computer-readable medium storing computer executable code at a user equipment (UE), the code when executed by a processor causes the processor to:
select a first physical uplink shared channel (PUSCH) to carry a first medium access control (MAC) control element (CE) (MAC-CE) having a first power headroom report (PHR);
determine a first value of the first PHR based on a third PUSCH;
select a second PUSCH to carry a second MAC-CE having a second PHR based on the third PUSCH or the first PUSCH; and
determine a second value of the second PHR based on a fourth PUSCH.
